(19) United States
(12) Patent Application Publication
(10) Pub. No.: US 2018/0025415 A1
(43) Pub. Date: Jan. 25, 2018

(54) VIRTUAL ONLINE TRADE SHOW

(71) Applicant: Tradeshow Inc., Fort Lauderale, FL (US)

(72) Inventors: Solomon Engel, Fort Lauderdale, FL (US); Aaron Ross Anderson, Angola, IN (US)

(21) Appl. No.: 15/670,694

(22) Filed: Aug. 7, 2017

Related U.S. Application Data
(63) Continuation-in-part of application No. 15/605,594, filed on May 25, 2017.
(60) Provisional application No. 62/341,440, filed on May 25, 2016.

(51) Int. Cl. G06Q 30/06; G06N 3/00; G06F 3/0481; G06Q 30/02

(52) U.S. Cl. CPC G06Q 30/0643; G06Q 30/0258; G06Q 30/0639; G06N 3/006; G06F 3/04815; G06Q 50/01

(57) ABSTRACT

Introduced here are platforms for creating virtual trade fairs that can be experienced by exhibitors and attendees via network-accessible interfaces accessible on a computing device (e.g., a mobile phone, tablet computer, or desktop computer). More specifically, a software program (e.g., a mobile application) executing on the computing device can display an interface that depicts the virtual show floor of a virtual trade fair. In some embodiments, an artificial intelligence (AI) operation is performed that identifies a specified series of virtual booths. The software program can then systematically guide a viewer through the specified series of virtual booths. Thus, the viewer can visit different virtual booths at the virtual trade fair without providing any user input (i.e., without directing the software program which virtual booths to visit).

### CROSS-REFERENCE TO RELATED APPLICATIONS

This application is a continuation-in-part of U.S. patent application Ser. No. 15/605,594, titled “Virtual Trade Show” and filed on May 25, 2017, which claims priority to U.S. Provisional Patent Application No. 62/341,440, titled “Virtual Trade Show” and filed on May 25, 2016, each of which is incorporated by reference herein in its entirety.

### RELATED FIELD

At least one embodiment of the present disclosure pertains to network-accessible platforms for accessing virtual trade shows, conventions, etc.

### BACKGROUND

A trade fair (also referred to as a “trade show”) is an exhibition that is organized so that companies in a specific industry can showcase and demonstrate their goods and services (collectively referred to as “products”), meet with industry partners and customers, study the activities of rivals, examine recent market trends and opportunities, etc. Examples of trade fairs include trade exhibitions, conventions, and expos. Some trade fairs are open to the public (e.g., customers), while others can only be attended by certified representatives (e.g., industry partners, vendors, and professionals).

Trade fairs often require that participants (also referred to as “exhibitors”) make a considerable marketing investment. Enterprises and individuals could be participants in a trade fair. Costs can include space rental, design and construction of displays, telecommunications and networking, travel, accommodations, and promotional literature and items to be given to attendees. Costs are also incurred at the trade fairs for various services, including electrical, booth cleaning, internet services, and drayage (i.e., material handling).

Host cities often promote trade fairs as a means of economic development. However, the significant costs involved before and during a trade fair often inhibit greater participation from both exhibitors and other attendees (e.g., individuals interested in a particular product being shown by an exhibitor).

### SUMMARY

Introduced here are platforms for creating virtual trade fairs that can be experienced by exhibitors and attendees via network-accessible interfaces accessible on a computing device (e.g., a mobile phone, tablet computer, or desktop computer). More specifically, a software program (e.g., a mobile application) executing on the computing device can display an interface that depicts the virtual show floor of a virtual trade fair. The virtual show floor could be shown from an overhead perspective or a third-person perspective.

In some embodiments, an artificial intelligence (AI) operation is performed that identifies a specified series of virtual booths. The software program can then systematically guide a viewer through the specified series of virtual booths. Thus, the viewer can visit different virtual booths at the virtual trade fair without providing any user input (i.e., without directing the software program which virtual booths to visit).

The software program may also continually monitor the boundaries of the interface to detect instances of user input. Responsive to receiving user input indicative of a selection of a virtual booth associated with an exhibitor, the software program can automatically display a booth interface that includes content chosen for display by the exhibitor.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references indicate similar elements.

FIG. 1 illustrates the high-level architecture of a platform 100 for generating virtual trade fairs.

FIG. 2 is a block diagram illustrating an example of a processing system 200 in which at least some operations described herein can be implemented.

FIG. 3A includes an overhead view of the virtual show floor.

FIG. 3B includes another overhead view of the virtual show floor.

FIG. 3C illustrates how a wing can be contained within its own virtual footprint on the virtual show floor.

FIG. 3D depicts how exhibitor booths, guest booths, and/or virtual stages can be added to a wing.

FIG. 4 includes a three-dimensional view of the virtual show floor.

FIG. 5A depicts the inside of a virtual exhibitor booth from the perspective of an attendee.

FIG. 5B depicts the inside of a virtual guest booth from the perspective of an attendee.

FIG. 5C depicts a virtual stage that may be accessible on the virtual show floor.

FIG. 6A depicts the inside of a virtual booth from the perspective of an exhibitor.

FIG. 6B also depicts the inside of a virtual booth from the perspective of an exhibitor.

FIG. 7 illustrates several different arrangements of multiple tables at a virtual booth.

FIG. 8 depicts a booth interface that includes a table arrangement icon in the upper right-hand corner.

FIG. 9 depicts a search interface through which a viewer can search a directory of exhibitors, sponsors, etc.

FIG. 10A illustrates how an attendee can be systematically guided through some or all of the virtual booths of a virtual trade fair.

FIG. 10B also illustrates how an attendee can be systematically guided through some or all of the virtual booths of a virtual trade fair.

FIG. 10C depicts an example of a menu of options.

FIG. 10D illustrates how the platform may visually mark those area(s) on the virtual show floor that have been visited by the viewer.

FIG. 11 depicts a search interface that enables a user to create a custom tour of the virtual trade fair.

FIG. 12A depicts a chat interface through which a viewer can communicate with other attendees of a virtual trade fair.

FIG. 12B depicts another chat interface through which a viewer can communicate with other attendees of a virtual trade fair.

FIG. 13 illustrates how labels can be shown at three different zoom levels.

FIG. 14A illustrates how different virtual show floor elements can be constructed.

FIG. 14B illustrates how different sections, blocks, and/or booths can be visually distinguished from one another.

FIG. 15 depicts a product interface through which a viewer can interact with one or more products exhibited at a virtual trade fair.

FIG. 16 depicts a purchase interface through which a viewer can complete a purchase of a product exhibited at a virtual trade fair.

FIG. 17A depicts a design interface through which an exhibitor can design a virtual booth.

FIG. 17B depicts another design interface through which an exhibitor can design a virtual booth.

FIG. 18 depicts a configuration interface through which the exhibitor can modify design elements of the virtual booth.

FIG. 19 depicts a content interface through which the exhibitor can choose which content will be shown at the virtual booth.

FIG. 20A illustrates how the exhibitor can select a box, and then choose which piece(s) of content to feature from within that box.

FIG. 20B illustrates how the exhibitor can edit the titles assigned to specific boxes, pieces of content, etc.

FIG. 20C illustrates how the user can individually manage pieces of content chosen for display.

FIG. 21 depicts two examples of confirmation pages that may serve as exhibitor overviews for the virtual trade fair.

FIG. 22A depicts a details interface that include details regarding a virtual trade fair.

FIG. 22B depicts another details interface that include details regarding a virtual trade fair.

FIG. 23 depicts a confirmation interface that may be shown to a viewer who has registered as an exhibitor.

FIG. 24 depicts an overview view of a virtual show floor that includes sponsor names, logos, etc.

FIG. 25 includes a high-level flow diagram illustrating how a remote server system can support a virtual trade fair.

FIG. 26 depicts a process for entering and loading the virtual show floor of a virtual trade fair.

FIG. 27 depicts a process for loading a virtual show floor while a viewer navigates a virtual trade fair.

FIG. 28 depicts a process for rendering attendees on the virtual show floor of a virtual trade fair.

FIG. 29A depicts a process for registering exhibitors and adding virtual booths to the virtual show floor of a virtual trade fair.

FIG. 29B illustrates an example of how the virtual show floor can be systematically populated and expanded to accommodate exhibitors.

FIG. 30 depicts a process for visiting a virtual booth at a virtual trade fair.

FIG. 31 depicts a process for sending and receiving messages at a virtual trade fair.

FIG. 32 depicts a process for creating a guided tour of multiple virtual booths at a virtual trade fair.

FIG. 33 depicts a process for populating a virtual show floor with simulated attendees.

FIG. 34 depicts a process for rendering a virtual show floor based on the current zoom level.

FIG. 35A depicts a show schedule that includes video events, one-on-one video chats, and/or other types of events.

FIG. 35B depicts a guest schedule that includes video events, one-on-one video chats, and/or other types of events.

FIG. 35C depicts an attendee schedule that includes video events, one-on-one video chats, and/or other types of events.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Introduced here is a platform for creating virtual trade fairs at relatively low cost and for which there is no need to travel. More specifically, the platform can create network-accessible interfaces through which viewers (e.g., attendees and exhibitors) can experience a virtual trade fair. Viewers can access the network-accessible interfaces on a computing device (e.g., a mobile phone, tablet computer, or desktop computer).

Embodiments may be described with reference to particular system configurations and networks. However, those skilled in the art will recognize that the features described herein are equally applicable to other system configurations, network types, etc. Moreover, some aspects of the technology can be embodied as special-purpose hardware (e.g., circuitry), programmable circuitry appropriately programmed with software and/or firmware, or as a combination of special-purpose hardware and programmable circuitry.

Accordingly, embodiments can include a machine-readable medium having instructions that may be used to program a computing device to generate a virtual show floor for a virtual trade fair, facilitate a registration process, etc. The computing device may also apply artificial intelligence-based (AI-based) algorithms to improve these processes.

### Terminology

References to “an embodiment” or “one embodiment” mean that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling, either direct or indirect, between two or more elements. The coupling/connection can be physical, logical, or a combination thereof. For example, two devices may be communicatively coupled to one another despite not sharing a physical connection.

When used in reference to a list of multiple items, the word “or” is intended to cover all of the following interpretations: any of the items in the list, all of the items in the list, and any combination of items in the list.

System Overview

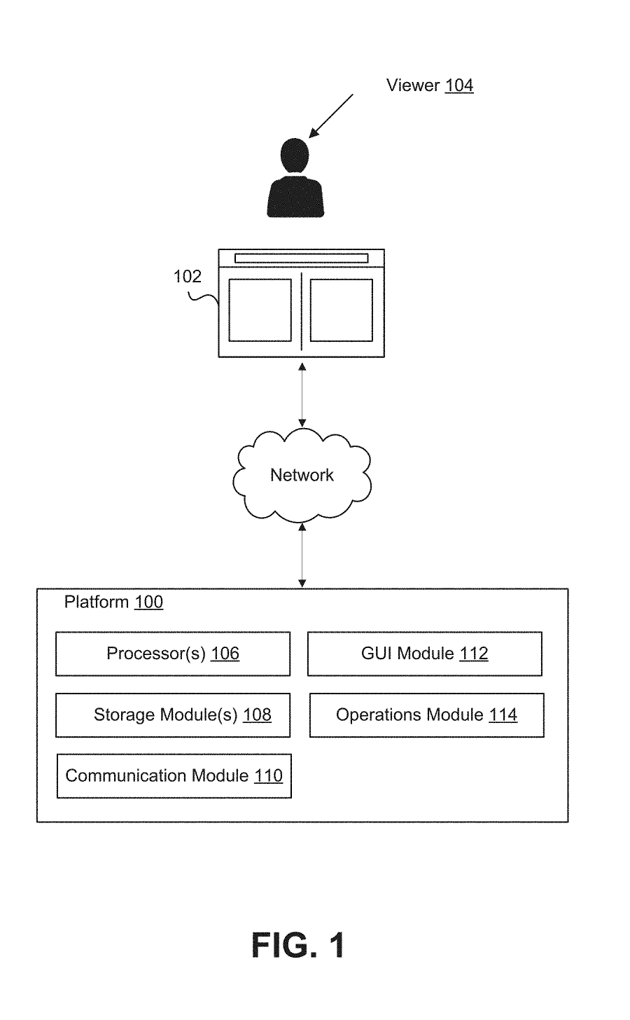

FIG. 1 illustrates the high-level architecture of a platform 100 for generating virtual trade fairs. A viewer 104 can interact with the platform 100 via a network-accessible interface 102. The viewer 104 could be, for example, an exhibitor presenting one or more products (e.g., goods or services) at a virtual trade fair or an attendee browsing the virtual trade fair. As further described below, elements of the network-accessible interface 102 may vary depending on the type of viewer accessing the network-accessible interface 102.

The platform 100 can facilitate the creation of online, virtual trade fairs where exhibitors and attendees gather to exhibit products, socialize with one another, view/interact with live content and/or pre-recorded content (e.g., video), and buy/sell/trade products in real time. As further described below, a virtual trade fair can include a variety of virtual stages, guest booths, and/or exhibitor booths that contain tables. Each table within an exhibitor booth can contain content the exhibitor has chosen for display. Content may include virtual items, images, boxes, folders, video, audio, etc., as well as other pieces of information that relate to the exhibitor.

The platform 100 can include one or more processors 106, a communication module 110, a graphical user interface (GUI) module 112, an operations module 114, and one or more storage modules 108. In some embodiments a single storage module includes multiple computer programs for performing different operations, while in other embodiments each computer program is hosted within a separate storage module. Embodiments of the platform 100 can include some or all of these modules/components, as well as other modules/components not shown here.

The processor(s) 106 can execute modules (e.g., the operations module 114) from instructions stored in the storage module(s) 108, which can be any device or mechanism capable of storing information. The communication module 110 can manage communications between the various components of the platform 100 and/or between the platform 100 and another computing device. For example, in some embodiments the platform 100 resides on a computing device (e.g., a mobile phone, tablet computer, or desktop computer) associated with the viewer 104, and the communication module 110 communicates with a remote server system (not shown) across a network. The remote server system can include one or more network-accessible computing devices (e.g., servers). In other embodiments, the platform 100 resides on the remote server system and the communication module 110 communicates with software executing on the computing device associated with the viewer 104. Thus, the platform 100 may be a cloud-based platform.

Those skilled in the art will recognize that the modules/components of the platform 100 could be distributed between the remote server system and the computing device associated with the viewer 104 in various ways. For example, some assets (e.g., financial information and sensitive registration information, such as username and password) may reside on the computing device associated with the viewer 104, while other assets (e.g., non-sensitive registration information, exhibitor content, invoice information, and communications) may reside on the remote server system. Computer program(s) for generating a virtual trade fair may also be distributed between the remote server system and the computing device associated with the viewer 104. For example, the remote server system may create a template of the virtual trade fair and the computing device associated with the viewer 104 may modify the template based on specified user preferences, prior transactions, viewing history, etc.

The GUI module 112 can generate the network-accessible interface 102 that allows the viewer 104 to experience the virtual trade fair. As further described below, the network-accessible interface 102 may enable the viewer 104 to interact with certain elements of the virtual trade fair. For example, the viewer 104 may be able to select virtual booths, complete purchase transactions, etc. The network-accessible interface 102 may be presented by a web browser, desktop software program, mobile application, or over-the-top (OTT) application. Accordingly, the network-accessible interface 102 may be viewed on a desktop computer, tablet computer, personal digital assistant (PDAs), mobile phone, game console (e.g., Sony PlayStation® or Microsoft Xbox®), music player (e.g., Apple iPod Touch®), wearable electronic device (e.g., a watch or fitness band), network-connected (“smart”) device (e.g., a television or home assistant device), virtual/augmented reality system (e.g., a head-mounted display such as Oculus Rift® and Microsoft Hololens®), or some other electronic device.

While embodiments may be described in the context of network-accessible interfaces, the interfaces need not necessarily be accessible via a network (e.g., the Internet). For example, the interfaces could instead be accessible within a self-contained desktop software program that does not require network access.

The operations module 114 can apply one or more operations to data accessible to the platform 100. For example, the operations module 114 may perform an optical character recognition (OCR) operation on registration information uploaded by the viewer 104 via the network-accessible interface 102 to identity relevant data elements. More specifically, the operations module 114 may automatically identify the viewer's name, preferences, billing information, etc. As another example, the operations module 114 may automatically parse content uploaded by the viewer 104 (e.g., an exhibitor) prior to populating a virtual booth at the virtual trade fair with the content.

The operations module 114 may employ various Natural Language Processing (NLP), artificial intelligence (AI), and/or machine learning (ML) operations to improve the processing of data accessible to the platform 100. Examples of ML operations include Naïve Bayes Classifier algorithms, K Means Clustering algorithms, Support Vector Machine algorithms, linear regression, logic regression, artificial neural networks, etc. The ML operation(s) may be chosen based on application (e.g., supervised or unsupervised learning) and optimized based on how the viewer 104 reacts to output(s) produced by the platform 100 (e.g., whether an output is subsequently used). For example, the platform 100 may modify how virtual show floors are created/populated based on, in the case of an exhibitor, whether the viewer 104 modifies how content is displayed in a virtual booth or, in the case of an attendee, how the virtual booths of the virtual trade fair are visited.

Often, the operations module 114 includes sub-modules that are dedicated to performing certain task(s), For example, the operations module 114 may include sub-modules for processing registration materials submitted by exhibitors/attendees, examining content uploaded by exhibitors, processing transactions (e.g., preparing invoices), managing communications between exhibitors/attendees (e.g., via a chat room or messaging system), etc.

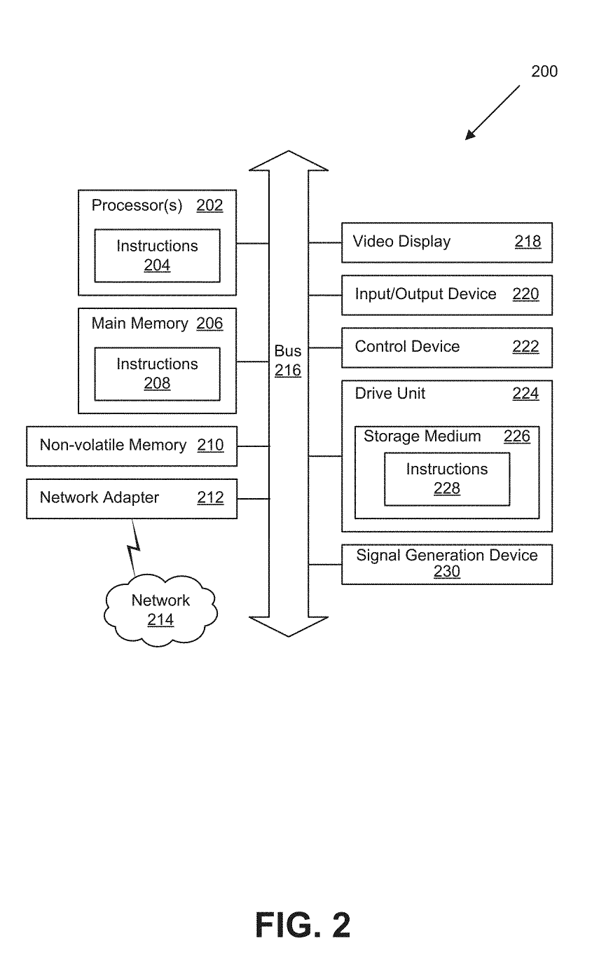

FIG. 2 is a block diagram illustrating an example of a processing system 200 in which at least some operations described herein can be implemented. The processing system may include one or more central processing units (“processors”) 202, main memory 206, non-volatile memory 210, network adapter 212 (e.g., one or more network interfaces), video display 218, input/output devices 220, control device 222 (e.g., keyboard/pointing devices), drive unit 224 including a storage medium 226, and signal generation device 230 that are communicatively connected to a bus 216. The bus 216 is illustrated as an abstraction that represents one or more separate physical buses, point-to-point connections, or both that are connected by appropriate bridges, adapters, or controllers. Therefore, the bus 216 can include a system bus, Peripheral Component Interconnect (PCI) bus or PCI-Express bus, HyperTransport interface, Industry Standard Architecture (ISA) bus, Small Computer System Interface (SCSI) bus, Universal Serial Bus (USB), Inter-Integrated Circuit (I²C or I2C) bus, or Institute of Electrical and Electronics Engineers (IEEE) standard 1394 bus (also referred to as “Firewire”).

In some embodiments the processing system 200 operates as part of a remote server system, while in other embodiments the processing system 200 operates as part of a computing device (e.g., a mobile phone, tablet computer, or desktop computer) that is communicatively connected to the remote server system via a wired channel or a wireless channel. Moreover, the processing system 200 could also operate as part of a computing device that is not communicatively connected to any remote server systems. Accordingly, the processing system 200 may be part of a desktop computer, tablet computer, personal digital assistant (PDA), mobile phone, game console (e.g., Sony PlayStation® or Microsoft Xbox®), music player (e.g., Apple iPod Touch®), wearable electronic device (e.g., a watch or fitness band), network-connected (“smart”) device (e.g., a television or home assistant device), virtual/augmented reality systems (e.g., a head-mounted display such as Oculus Rift® and Microsoft Hololens®), or another electronic device capable of executing a set of instructions (sequential or otherwise) that specify action(s) to be taken by the processing system 200.

While the main memory 206, non-volatile memory 210, and storage medium 226 (also referred to as a “machine-readable medium”) are shown to be a single medium, the term “storage medium” should be taken to include a single medium or multiple media (e.g., centralized or distributed databases, and/or associated caches and servers) that store one or more sets of instructions 228. The term “storage medium” shall also be taken to include any medium that is capable of storing, encoding, or carrying a set of instructions for execution by the processing system 200 and that cause the processing system to perform any of the methodologies of the embodiments.

In general, the routines executed to implement the embodiments may be implemented as an operating system process or a dedicated application, component, program, object, module, or sequence of instructions (which are collectively referred to as “computer programs”). The computer program typically comprises one or more instructions (e.g., instructions 204, 208, 228) set at various times in various memory/storage devices in a computing device, and that, when read and executed by the processor(s) 202, cause the processing system 200 to perform operations to execute various aspects of the embodiments.

Moreover, while certain embodiments may be described in the context of fully functioning computing devices, those skilled in the art will appreciate that the embodiments are capable of being distributed as a software program product in a variety of forms. The disclosure applies equally regardless of the particular type of machine or computer-readable media used to actually effect the distribution.

Further examples of machine-readable (storage) media include recordable media such as volatile and non-volatile memory devices 210, floppy disks and other removable disks, hard disk drives, optical disks (e.g., Compact Disk Read-Only Memory (CD ROMS) and Digital Versatile Disks (DVDs)), and transmission media, such as digital communication links and analog communication links.

The network adapter 212 enables the processing system 200 to mediate data in a network 214 with an entity that is external to the processing system 200 through any known/convenient communications protocol supported by the processing system 200 and the external entity. For example, the processing system 200 and the external entity may communicate via Wi-Fi, Bluetooth®, Near Field Communication (NFC), cellular, infrared, radio-frequency identification (RFID), etc. Accordingly, the network adapter 212 can include a network adaptor card, a wireless network interface card, a router, an access point, a wireless router, a switch, a multilayer switch, a protocol converter, a gateway, a bridge, a bridge router, a hub, a digital media receiver, a repeater, etc.

The techniques introduced here can be implemented by, for example, programmable circuitry (e.g., one or more microprocessors) programmed with software and/or firmware, special-purpose hardwired (i.e., non-programmable) circuitry, or in a combination of such forms. Circuitry can be in the form of application-specific integrated circuits (ASICs), programmable logic devices (PLDs), field-programmable gate arrays (FPGAs), etc.

### Technology Overview

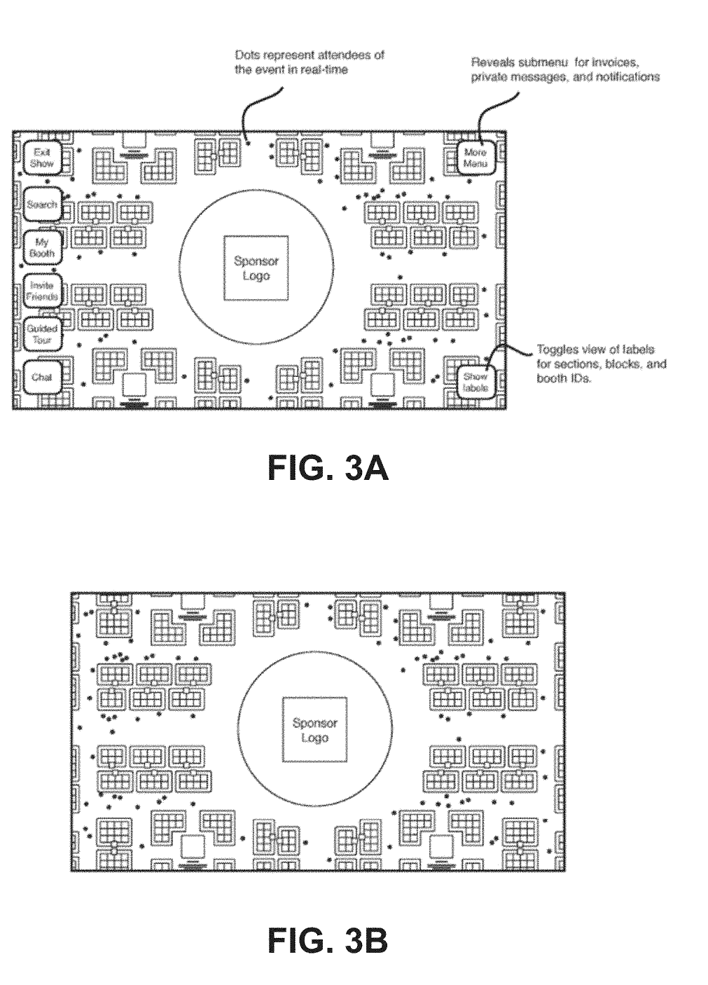

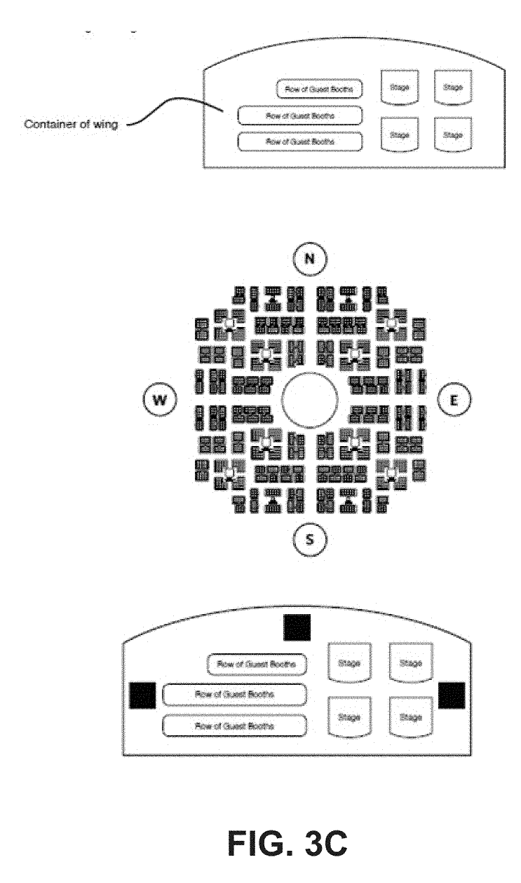

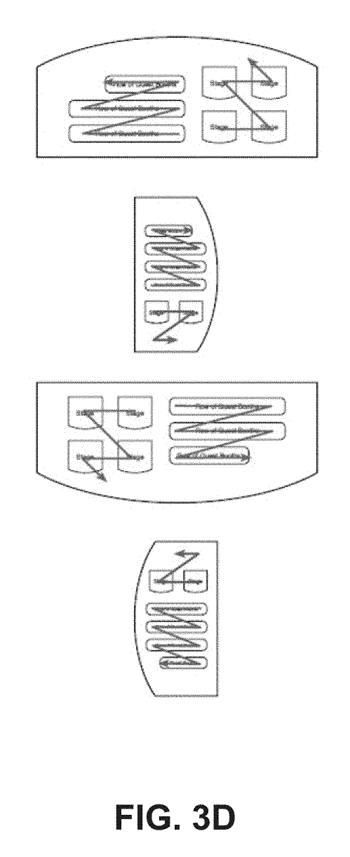

The virtual show floor of a virtual trade fair can be viewed in several different ways. FIGS. 3A-B, for example, include overhead views of the virtual show floor. The virtual show floor includes a series of virtual booths corresponding to different exhibitors. In some embodiments, the virtual show floor also includes a central graphic that includes alphanumeric characters and/or images. For example, the central graphic could include the name or logo of the virtual trade fair, a sponsor, an exhibitor, etc.

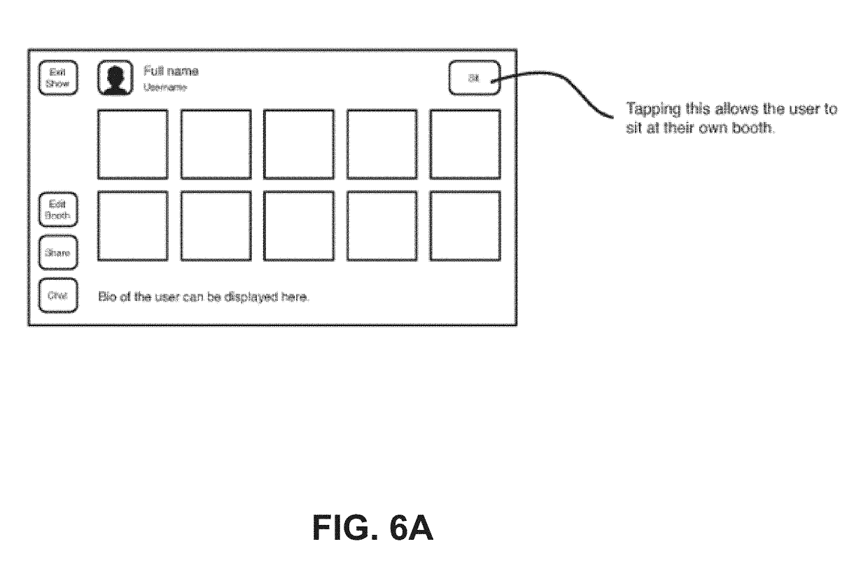

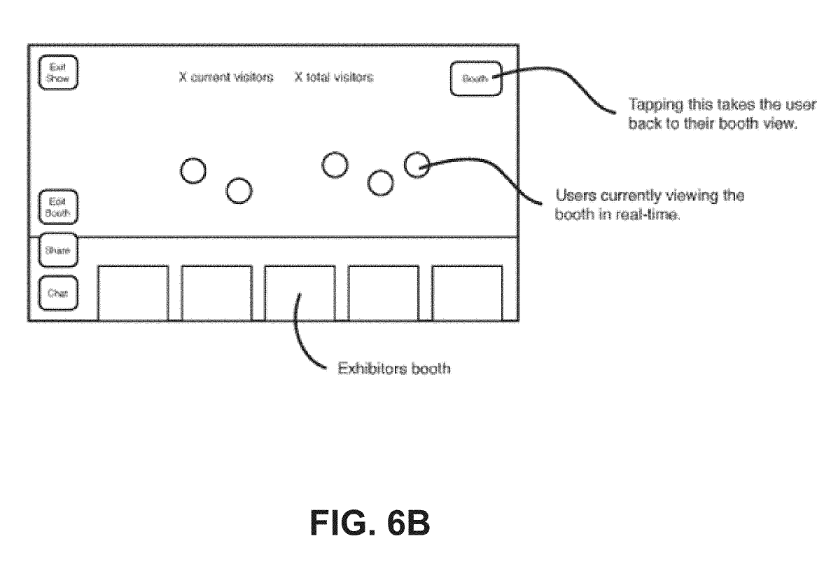

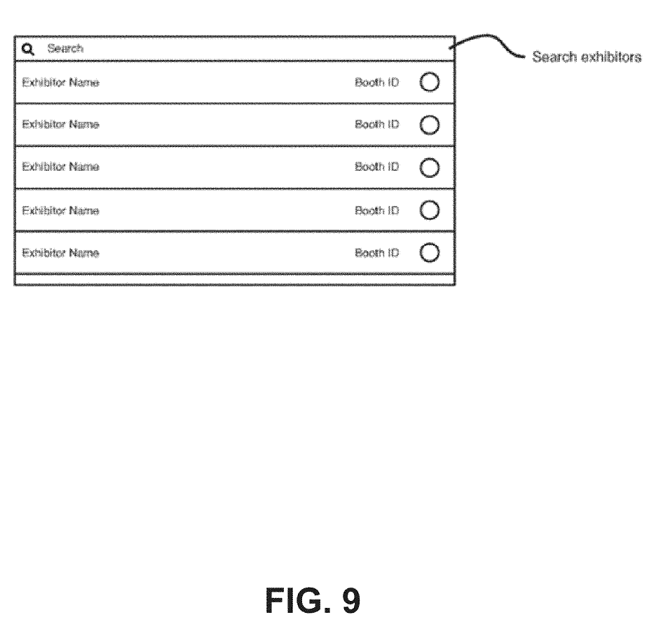

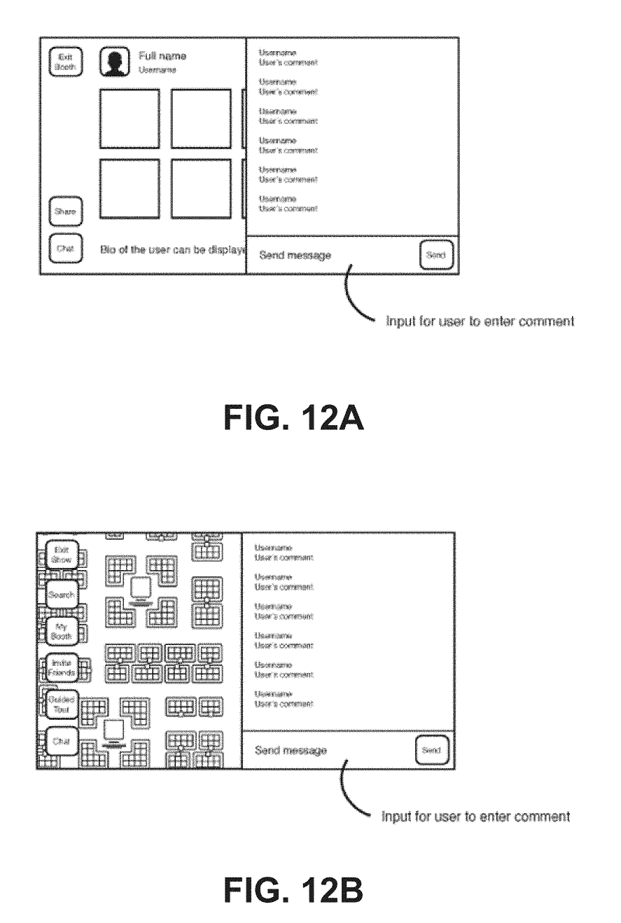

The overhead view of the virtual show floor can also include an overlay menu that includes one or more graphical icons. Examples of graphical icons include:
An exit icon that, upon selection, can cause the viewer to exit the overhead view of the virtual show floor or the virtual trade fair entirely.
A search icon that, upon selection, can cause display of a search interface (e.g., the search interface of FIG. 9).
A booth icon that, upon selection, can cause display of a booth interface (e.g., the booth interfaces of FIGS. 6A-B). The booth icon may only be shown to viewers who are registered as exhibitors.
An invite icon that, upon selection, can allow the viewer to invite prospective viewers to browse the virtual trade fair, a specific virtual booth, etc. In some embodiments invites are associated with a communication handle (e.g., an email address, phone number, or physical address) provided during a registration process, while in other embodiments the invites are associated with a social media handle (e.g., a Facebook® account, Twitter® account, or LinkedIn® account).
A tour icon that, upon selection, can cause the viewer to be systematically guided through the virtual booths on the virtual show floor.
A chat icon that, upon selection, can cause display of a chat interface (e.g., the chat interfaces of FIGS. 12A-B).
A menu icon that, upon selection, can cause display of a dropdown menu including subentries for accessing additional information. For example, the dropdown menu may include an invoice subentry that reveals invoice(s) for purchase(s) made by the viewer, a message subentry that reveals private messages involving the viewer, and/or a notification subentry that reveals pending notifications associated with the virtual trade fair.
A label icon that, upon selection, can toggle whether labels for sections, blocks, virtual booths, etc., are visible. A label could include an identifier (e.g., the name of the exhibitor), a notification of a sale, an indication as to the type of product(s) being exhibited, etc.

Embodiments of the interface can include some or all of these graphical icons, as well as other graphical icons not shown here. Moreover, the graphical icons need not be geometrical shapes that are labeled with alphanumeric characters. For example, the exit icon could instead be represented with a red “X.”

The overhead view of the virtual show floor can also include a separate visual representation for each attendee of the virtual trade show. Here, for example, a series of dots move along the virtual show floor in real time as the corresponding attendees visit different virtual booths.

In some embodiments, the series of dots may be visually distinguishable from one another. For example, each dot may be rendered in a different color based on a characteristic of the corresponding viewer (e.g., whether the viewer is an exhibitor or an attendee, which topic(s) the viewer is interested in, whether the viewer is able to purchase an exhibited product, etc.).

As shown in FIG. 3B, some or all of the interface elements (e.g., the graphical icons) may disappear while a viewer navigates the virtual show floor. For example, in some embodiments all of the interface elements disappear from view as the viewer navigates the virtual show floor, while in other embodiments a subset of the interface elements (e.g., the menu icon and/or the exit icon) remain visible while the viewer navigates the virtual show floor.

The virtual show floor can also include one or more wings that can be visited by viewers. A “wing” is a self-contained section that includes additional virtual booths, stages, guest booths, etc. FIG. 3C illustrates how a wing can be contained within its own virtual footprint on the virtual show floor. Wings can also be branded by uploading an image that is placed within the wing. For example, three instances of the same image may be located in the black squares shown in FIG. 3C. As another example, single instances of three different images may be located in the black squares.

In some embodiments, a platform (e.g., platform 100 of FIG. 1) or an administrator defines positional context. Such context may be useful, for example, when the virtual show floor includes multiple wings (e.g., a North wing, a South wing, an East wing, and a West wing). The administrator typically manages the platform, and thus may be responsible for overseeing multiple virtual trade fairs.

FIG. 3D depicts how exhibitor booths, guest booths, and/or virtual stages can be added to a wing. Moreover, the wing can be scaled appropriately as content is added. In some embodiments, a new wing is automatically created responsive to determining that the amount of content has reached a specified threshold. For example, each wing may only accommodate four guest booths, so a new wing may be created when a fifth guest booth is generated.

The platform may also display simulated attendees to improve the experience of the viewer. Simulated attendees give a sense of greater activity on the virtual show floor, often resulting in higher engagement. The total number of simulated attendees visible at any given point in time may depend on the total number of registrations, the time of day, etc.

Generally, virtual booths whose exhibitors have a higher popularity score will have a higher probability of a simulated attendee visiting their booth. The popularity score could be based on, for example, number of social media followers, number of virtual trade fairs in which the exhibitor previously participated, number of purchases the exhibitor has completed, etc.

Simulated attendees can be divided into several types of categories:
Browsers: These viewers generally tour the virtual trade fair and browse different virtual booths. For example, a browser could experience a guided tour of the virtual show floor. Browsers can be programmed to randomly visit virtual booths (e.g., every 4-10 virtual booths) for a specified period of time (e.g., 1-5 minutes).
Searchers: These viewers act as though they are searching for a specific product, so they will typically visit a virtual booth for a longer period of time (e.g., 5-10 minutes) before visiting another virtual booth.
Diggers: These viewers act as though they are digging through an exhibitor's content. Consequently, these viewers will typically visit a virtual booth for an even longer period of time (e.g., 10-30 minutes) before visiting another virtual booth.

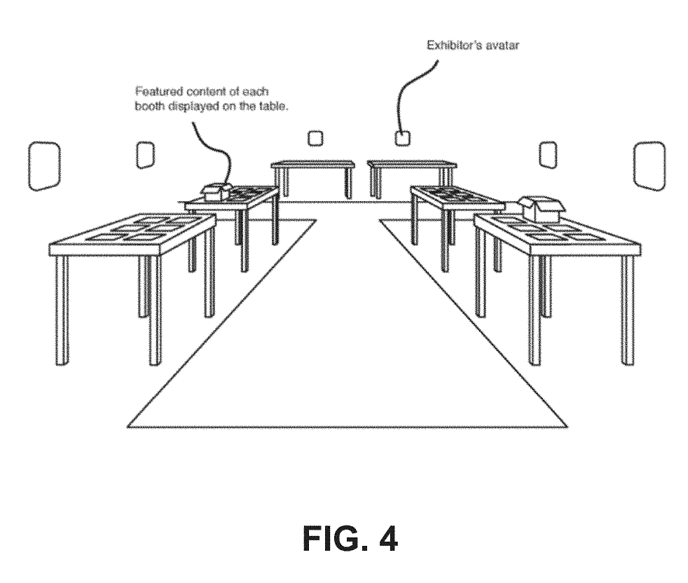

FIG. 4, meanwhile, includes a three-dimensional view of the virtual show floor. In some embodiments, a viewer is asked whether she would like to view the virtual show floor of the virtual trade fair from an overhead perspective or a three-dimensional perspective. In other embodiments, a platform (e.g., platform 100 of FIG. 1) may intelligently switch between the different views. For example, an overhead view may be shown to the viewer until the viewer chooses to begin a guided tour (at which point the three-dimensional view could be shown).

Much like the overhead view, the three-dimensional view of the virtual show floor can include a series of booths corresponding to different exhibitors. Each booth can include one or more products (e.g., goods or services) that are being shown by the corresponding exhibitor. An avatar could also be placed proximate to each booth. The avatar may be, for example, a logo associated with the corresponding exhibitor or a digital representation of a person with whom the viewer can interact (e.g., via the chat interfaces of FIGS. 12A-B).

The three-dimensional view can facilitate a more immersive experience, particularly when viewed on a head-mounted display such as the Oculus Rift® or Microsoft Hololens®. Certain embodiments have been described in the context of virtual reality for the purpose of illustration only. Those skilled in the art will recognize that the technology is equally applicable to augmented reality (e.g., physical trade fairs where some exhibitors are unable to attend).

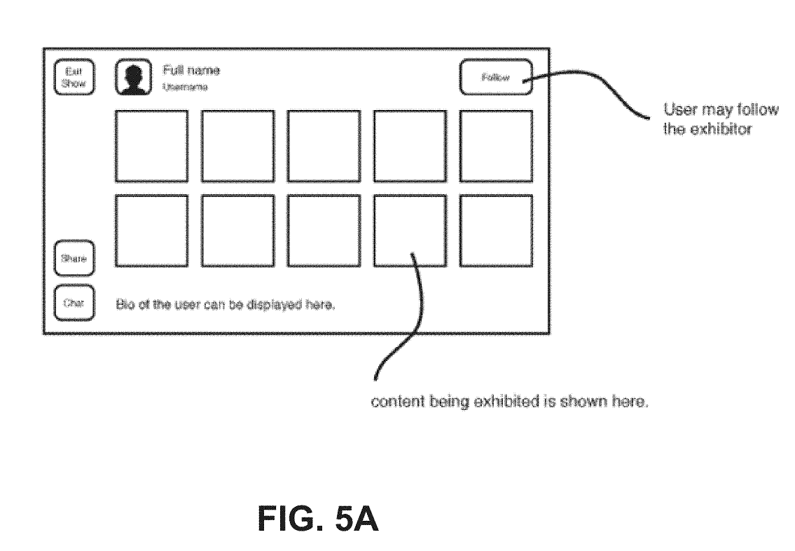

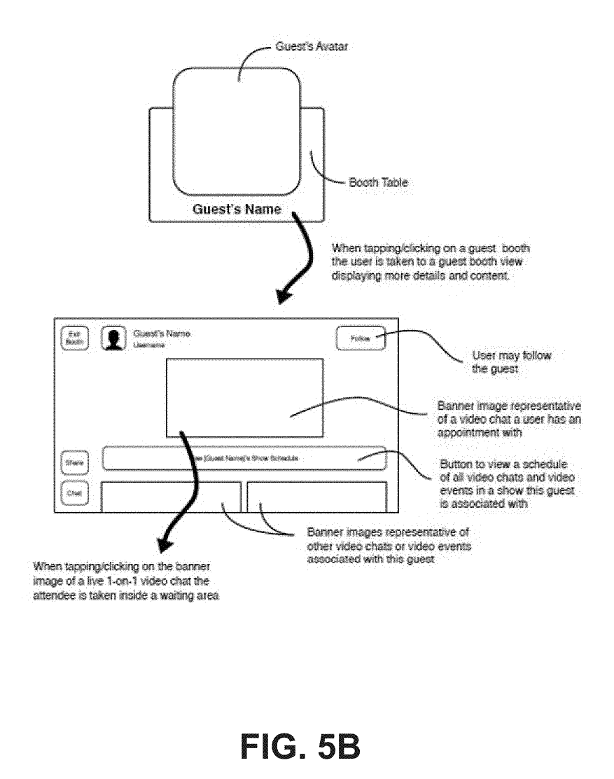

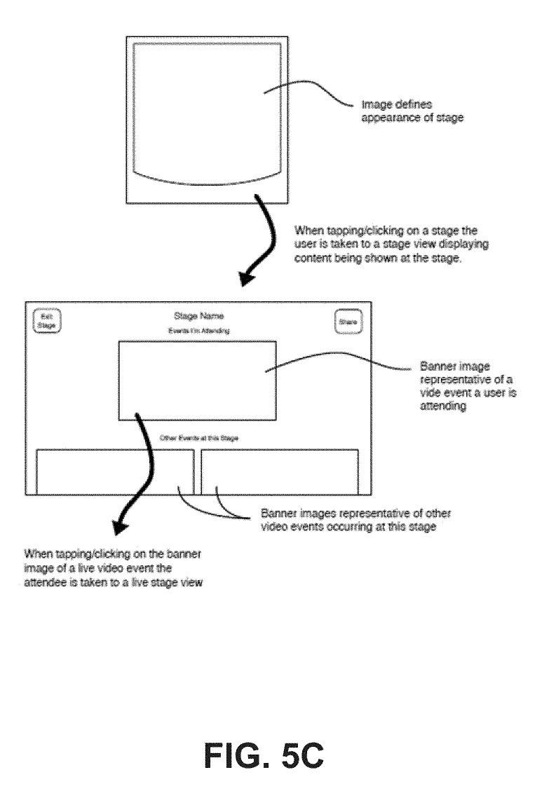

FIG. 5A depicts the inside of a virtual booth from the perspective of an attendee. When the virtual booth is selected via the virtual show floor, the viewer can be taken to another interface (also referred to as an “exhibitor booth interface” or “booth interface”) that includes the booth details shown here. More specifically, responsive to receiving user input indicative of a selection of a particular virtual booth associated with a particular exhibitor, a computing device (e.g., a mobile phone) can cause display of a second interface that includes content chosen for display by the particular exhibitor. The booth interface showing the product(s) exhibited within the virtual booth may at least partially overlay the interface depicting the virtual show floor (e.g., the interfaces of FIGS. 3A-B or FIG. 4).

The booth interface can present pieces of content (e.g., images, descriptions, and/or audio pertaining to specific products) the particular exhibitor selected for display during a registration process. As further described below, the virtual booth could include multiple tables associated with different products. In such embodiments, the booth interface may also allow the viewer to readily visit different tables within the virtual booth.

The booth interface can also include biographical information regarding the particular exhibitor (e.g., a name, physical address, and/or web address) or the attendee (e.g., a name and/or username). In some embodiments, the booth interface includes a short description of the particular exhibitor or of the product(s) being shown. The short description may also be referred to as the exhibitor's “pitch.”

The booth interface can also include one or more graphical icons. Examples of graphical icons include:
An exit icon that, upon selection, can cause the viewer to exit the booth interface or the virtual trade fair entirely.
A share icon that, upon selection, allows the viewer to invite prospective viewers to browse the particular virtual booth.
A chat icon that, upon selection, can cause display of a chat interface (e.g., the chat interfaces of FIGS. 12A-B) for communicating with the particular exhibitor.
A follow icon that, upon selection, can cause the viewer to follow the particular exhibitor. In some embodiments, selection of the follow icon causes the particular exhibitor to be notified that the viewer would like to receive additional information at a specified communication handle (e.g., email address, phone number, or physical address) provided by the viewer.

In other embodiments, selection of the follow icon causes the viewer to automatically begin following a social media handle (e.g., a Facebook® account, Twitter® account, or LinkedIn® account) associated with the particular exhibitor. In other embodiments, selection of the follow icon causes the viewer to automatically begin following the particular exhibitor on the platform used to access the virtual trade fair (e.g., platform 100 of FIG. 1).

In some embodiments, the booth interface includes arrows that allow the viewer to easily visit virtual booths associated with other exhibitors and/or different tables associated with the same exhibitor. The arrows may be arranged along the left side, right side, top side, and/or bottom side. For example, arrows arranged along the left/right sides could be used to navigate the table(s) associated with a single exhibitor, while arrows arranged along the top/bottom sides could be used to navigate the virtual booth(s) associated with multiple exhibitors. Other input mechanisms may also be enabled (e.g., the viewer may be able to swipe left/right on a touchscreen).

FIG. 5B depicts the inside of a guest booth from the perspective of an attendee. Guest booths are a type of virtual booth that highlights specifies guests on the virtual show floor. For example, a guest booth may provide attendee(s) an access point to one-on-one video chats.

A guest booth may be visible on the virtual show floor. Here, for example, a booth table including an avatar can be shown on the virtual show floor. After a viewer selects the guest booth, a guest booth interface can be shown. The guest booth interface may share some elements in common with the exhibitor booth interface of FIG. 5A. For example, the guest booth interface may include a follow icon that, upon selection, can cause the viewer to follow the guest. In some embodiments the viewer will begin following the guest on whichever network-accessible platform is used to access the content (here, the platform for creating virtual trade fairs), while in other embodiments the viewer will begin following a social media handle (e.g., a Facebook® account, Twitter® account, or LinkedIn® account) associated with the guest.

In some embodiments, the guest booth interface facilitates one-on-one video chats. Thus, the guest booth interface can include:
A banner image representative of a video chat the viewer has an appointment for. Upon selection of the banner image, the viewer may be directed \ to a waiting area before the video chat begins.
Supplementary banner image(s) representative of other video chats or video events associated with the guest.
A scheduling icon that, upon selection, can permit the viewer to view a schedule of upcoming video chats and/or video events involving the guest during the virtual trade fair, submit a request to schedule a video chat session, etc.

FIG. 5C depicts a virtual stage that may be accessible on the virtual show floor. The virtual stage may be represented as, for example, a section of the virtual show floor dedicated to showing content provided by specific exhibitors, guests, sponsors, etc. For example, a virtual stage may allow live streaming and/or pre-recorded video (collectively referred to as a “video event”) to be broadcast at any point during the virtual trade fair.

Virtual stages may be shown on the virtual show floor. Here, for example, a virtual stage including an image specifying the type of content being shown in the video event. After a viewer selects the virtual stage, a virtual stage interface can be shown. The virtual stage interface can include a banner image representation of the video event, supplementary banner image(s) representative of other video event(s) occurring at the virtual stage, etc.

FIGS. 6A-B depict the inside of a virtual booth from the perspective of an exhibitor. The booth interface of FIG. 6A may be largely similar to the booth interface of FIG. 5A.

Piece(s) of content selected by the exhibitor can be displayed in various ways within the virtual booth. In fact, virtual booths can be of various shapes and sizes based on the number content pieces (e.g., the number of images to be shown). Generally, content is shown in boxes that are arranged in rows and columns. In some embodiments, an exhibitor can readily rearrange the sequence in which attendees view content in the virtual booth by rearranging the boxes (e.g., using a drag-and-drop interface mechanism). In other embodiments, content is displayed systematically on behalf of the exhibitor. For example, the boxes could be arranged based on similarity to an attendee preference specified during a registration process (e.g., an interest in products of a certain type, price, etc.).

If there are multiple tables within the virtual booth, then exhibitor content can be placed in a defined order starting from the first table. For example, each table may be associated with products of a certain type or price range. As another example, each table may include a specified assortment of products of different types, prices, etc.

The booth interface of FIG. 6A can also include a sit icon that, upon selection, causes the viewer (here, an exhibitor) to “sit” at the virtual booth and observe attendees browsing the product(s) being exhibited. For example, FIG. 6B illustrates how each attendee visiting the virtual booth can be represented as a separate visual representation. Each visual representation may be arranged proximate to the product currently being viewed by the corresponding attendee. In such embodiments, the visual representations can move in real time as new attendees enter the virtual booth, existing attendees leave the virtual booth, and existing attendees view different products, tables, etc. Alternatively, the visual representations may be randomly placed to more generally illustrate how many viewers are visiting the virtual booth. In some embodiments, the booth interface also includes a current count of attendees visiting the virtual booth (here, “X current visitors”) and/or a historical count of attendees who have visited the virtual booth during the virtual trade fair (here, “X total visitors”).

The exhibitor may also be able to interact with a given attendee by simply selecting the visual representation corresponding to the given attendee. For example, the exhibitor may choose to interact with attendees who spent a significant amount of time browsing the product(s), make a return visit to the virtual booth, etc. Selection of a visual representation may cause display of a chat interface (e.g., the chat interfaces of FIGS. 12A-B). Additionally or alternatively, selection of the visual representation may cause information about the given attendee (e.g., name, contact information, product(s) being browsed) to be saved to facilitate subsequent contact.

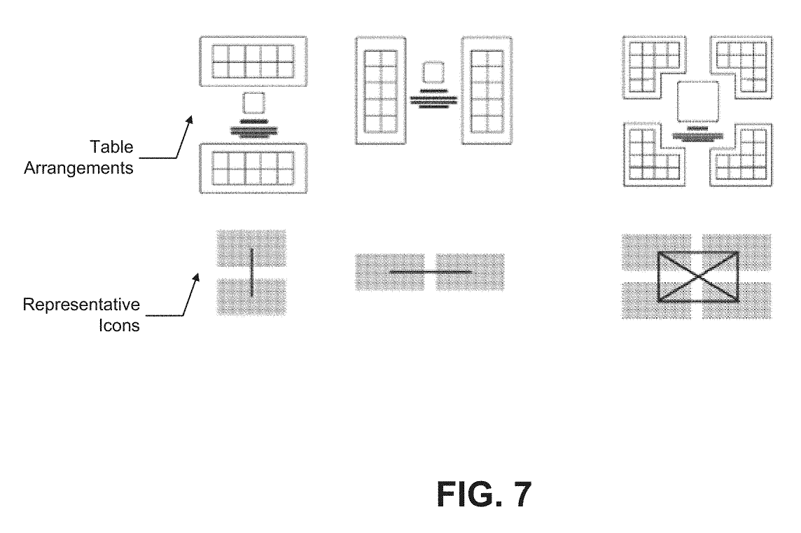

FIG. 7 illustrates several different arrangements of multiple tables at a virtual booth. When the virtual booth includes multiple tables, an icon can be used to indicate which arrangement is being used.

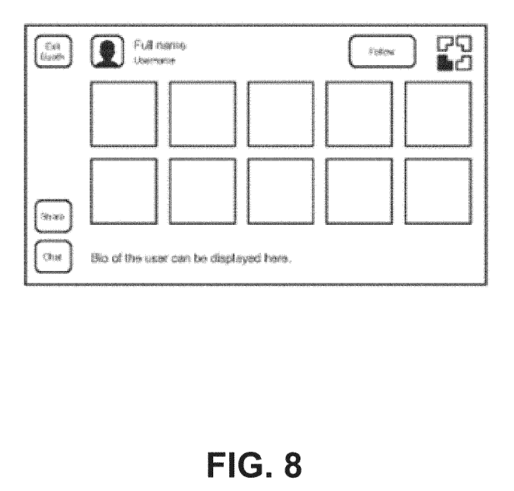

For example, FIG. 8 depicts a booth interface that includes a table arrangement icon in the upper right-hand corner. The table arrangement icon may indicate which table a viewer is currently visiting within the virtual booth. Here, for example, the table currently being visited is visually distinguished from the other tables.

The table arrangement icon could also be used to navigate multiple tables associated with a single exhibitor. Said another way, selecting different parts of the icon may cause the viewer to be navigated to other tables within the virtual booth.

FIG. 9 depicts a search interface through which a viewer can search a directory of exhibitors, sponsors, etc. The search interface (also referred to as a “virtual trade fair directory”) can include a search bar that permits the entry of queries for certain exhibitors. Additionally or alternatively, a list of exhibitors may be displayed within the search interface. The list of exhibitors may be sorted alphabetically, by popularity, by registration date, etc. Selecting an exhibitor may take the user directly to the booth interface associated with the exhibitor.

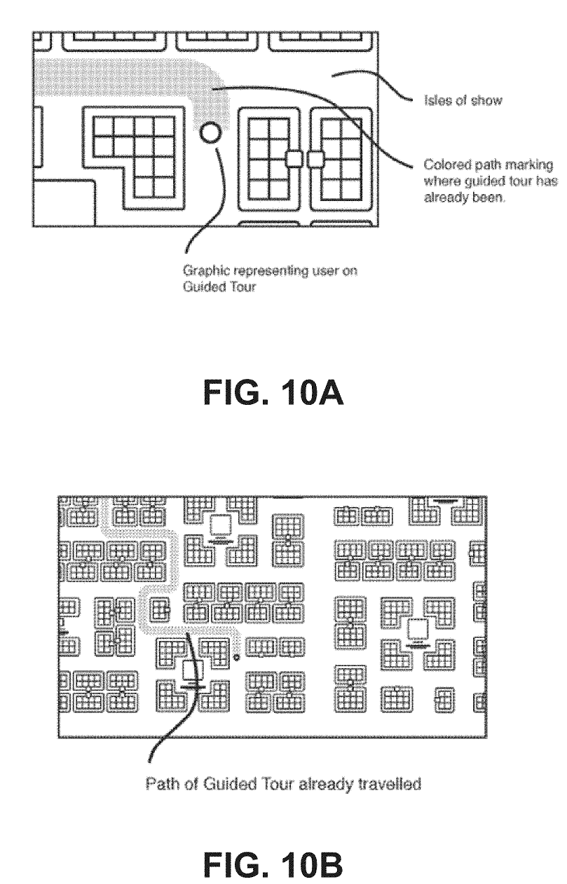

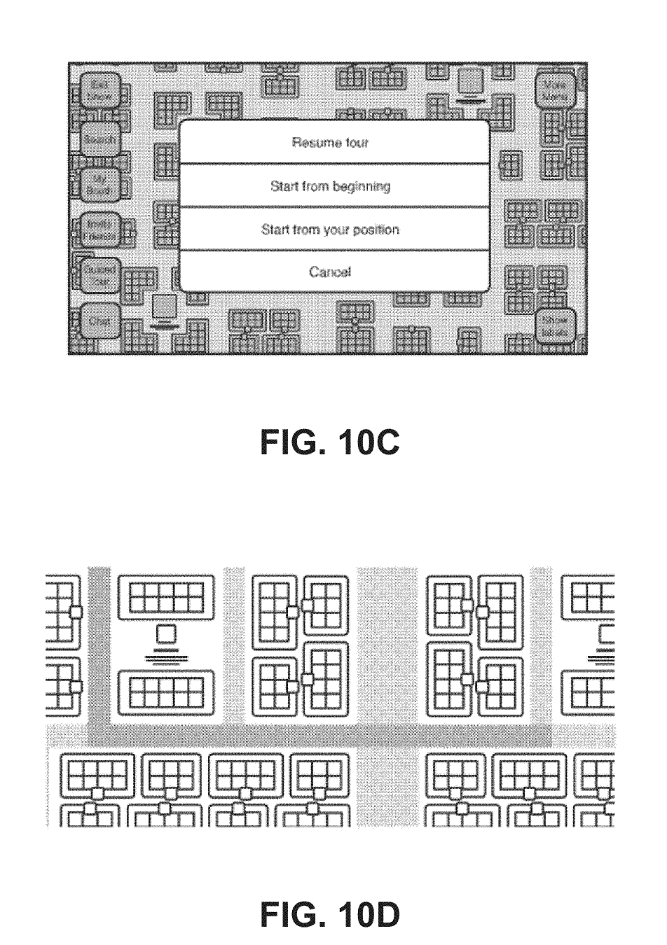

FIGS. 10A-B illustrate how an attendee can be systematically guided through some or all of the virtual booths of a virtual trade fair. In some embodiments, AI operation(s) are applied to systematically guide a viewer (e.g., an attendee) through areas of the virtual trade fair that the viewer has yet to explore. As the viewer takes a guided tour of the virtual trade fair, the viewer will see virtual booths corresponding to different exhibitors and, in some embodiments, other attendees that are visually represented (e.g., as separate dots) throughout the aisles.

As shown in FIG. 10A, a graphic may represent the current position of the viewer on the virtual show floor. A path may also be shown that illustrates which virtual booth(s) the viewer has already visited. The path may be a particular color, pattern (e.g., crosshatch), etc.

Additionally or alternatively, an interface (e.g., the interfaces of FIG. 3A-B or FIG. 4) may enable a viewer to manually navigate the virtual show floor through one or more forms of user input (e.g., gestures, verbal commands, pointing devices). Thus, in some embodiments, the viewer can pause the guided tour by interacting with the interface (e.g., by tapping or clicking). The viewer can then tap a tour icon to either start the guided tour over again or continue from where the viewer left off. The interface may also facilitate interactions with exhibitors at any time throughout the guided tour. For example, a viewer may be able to see additional information about an exhibitor by moving a pointing device (e.g., a computer mouse) over the virtual booth corresponding to the exhibitor. As another example, a viewer may be able to travel directly to a booth interface (e.g., the booth interface of FIG. 5A) by selecting the corresponding virtual booth. As yet another example, a viewer may be able to mark a first exhibitor for further review (e.g., by selecting the corresponding virtual booth a single time) and visit a second exhibitor (e.g., by selecting the corresponding virtual booth multiple times).

When the viewer taps the tour icon, a menu of options may be presented. FIG. 10C depicts an example of a menu of options. Options can include resuming the guided tour from where the viewer previously left off, starting the guided tour over from the viewer's current position on the virtual show floor, starting the guided tour over from the beginning, or closing the menu of options by selecting cancel. Any of these could be chosen by the platform to be the default option.

FIG. 10D illustrates how the platform may visually mark those area(s) on the virtual show floor that have been visited by the viewer. As noted above, the path may be a particular color, pattern (e.g., crosshatch), etc. In some embodiments, the path may include different types of fills in order to convey different types of information. For example, the path of a guided tour may be represented as a first color (e.g., red) by default, but segments corresponding to virtual booths at which the viewer stopped or indicated an interest in stopping may be represented as a second color (e.g., green).

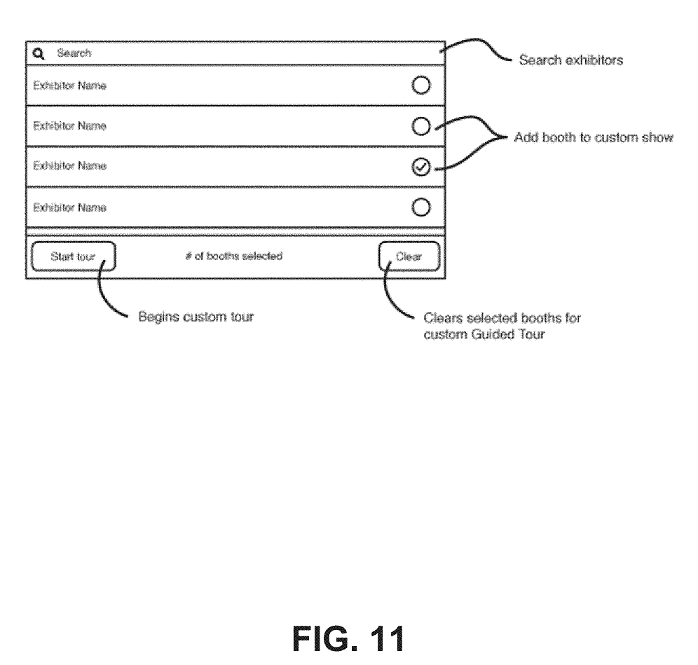

FIG. 11 depicts a search interface that enables a user to create a custom tour of the virtual trade fair. More specifically, the search interface can allow the user to select a series of exhibitors (e.g., by selecting a radio button element associated with each exhibitor) who will be visited during the custom tour.

After selecting at least one exhibitor, a toolbar may be shown adjacent to the search interface. The toolbar may include icons for managing the custom tour and/or information regarding the custom tour (e.g., the number of exhibitors who have been selected). Here, for example, the toolbar includes separate icons for initiating the custom tour and clearing the selected exhibitor(s) from the custom tour.

FIGS. 12A-B depict chat interfaces through which a viewer can communicate with other attendees of a virtual trade fair. A chat interface may be invoked, for example, responsive to detecting user input indicative of a selection of a chat icon on a booth interface (e.g., the booth interface of FIG. 5A) or a virtual representative on a main show floor interface (e.g., the interface of FIG. 4).

In some embodiments, selecting the chat icon opens a chat between a single attendee and an exhibitor. In other embodiments, selecting the chat icon opens a group chat that includes any attendees currently viewing a virtual booth. Accordingly, the attendees that are visiting the virtual booth at that time may be able to chat with one another using a real-time communication channel. The group chat may (or may not) include the exhibitor. As shown in FIG. 12B, selecting the chat icon shown in the main show floor interface may open a group chat that includes all attendees of the virtual trade fair,

Specific sections, blocks, and/or booths visible on the virtual show floor of the virtual trade fair may also contain their own labels. As noted above, the main show floor interface (e.g., the interface of FIG. 3A) may include a label icon that allows a viewer to toggle whether these labels are shown.

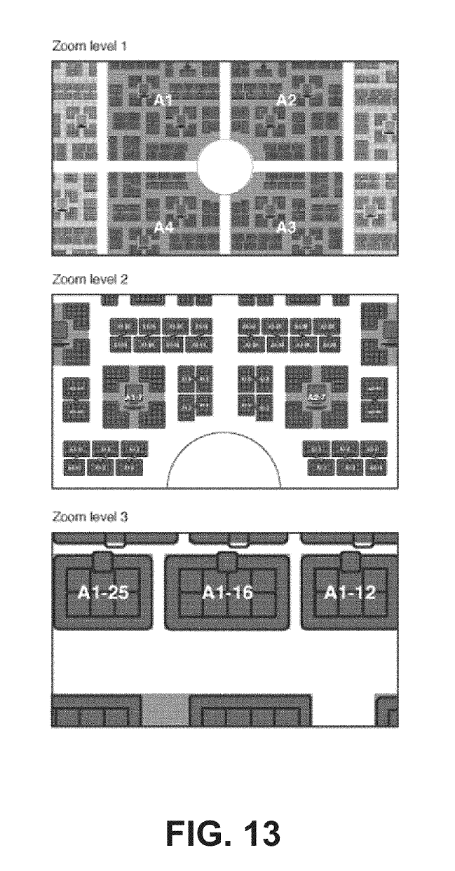

FIG. 13 illustrates how labels can be shown at three different zoom levels. The labels may appear different based on the zoom level of the virtual show floor. Here, for example, section/block labels (e.g., A1, A2) are visible at a first zoom level, while individual booth identifiers (e.g., A1-25, A1-16) are visible at a second zoom level and a third zoom level.

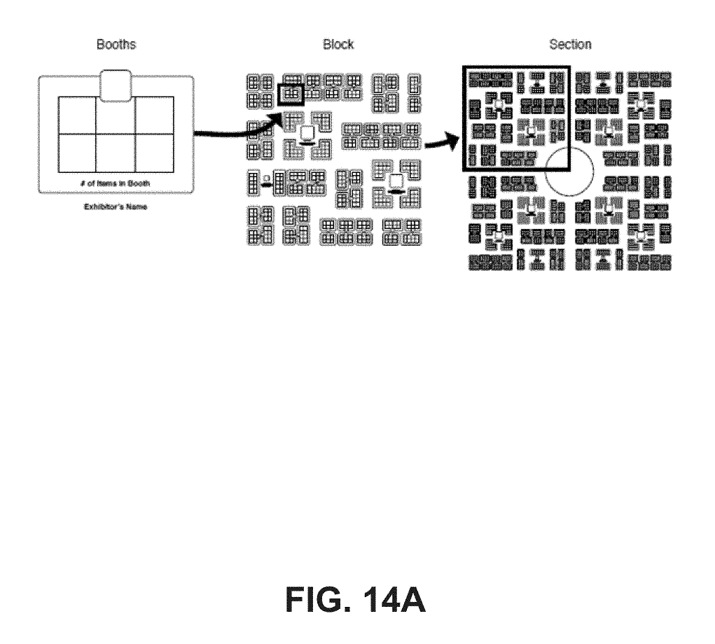

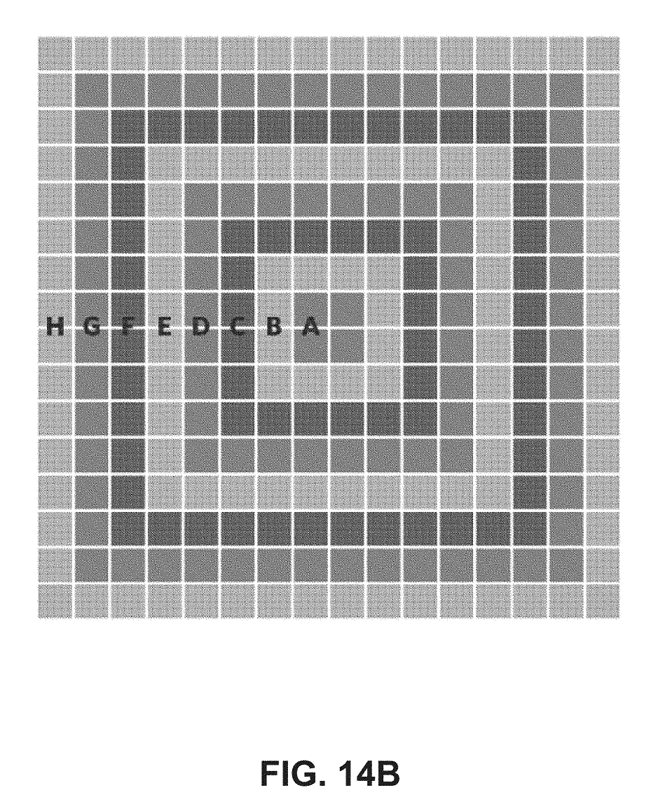

FIG. 14A illustrates how different virtual show floor elements can be constructed. Generally, the virtual show floor is comprised of one or more sections. Each section can be comprised of one or more blocks, while each block can be comprised of one or more virtual booths. Such a scheme allows the virtual show floor to be readily constructed regardless of how many exhibitors have registers, and then readily modified as new exhibitors are added, existing exhibitors are removed, etc. such a scheme also allows naming schemes, color schemes, etc., to be easily administered across the entire virtual show floor.

FIG. 14B illustrates how different sections, blocks, and/or booths can be visually distinguished from one another. More specifically, FIG. 14B illustrates how each section on the virtual show floor can be color coded as it expands in a radial pattern. Sections, blocks, and/or booths may alternate color schemes to aid in visual separation. The color schemes may repeat moving outward, periodically (e.g., every three virtual booths), etc. Additionally or alternatively, color schemes may be used to visually distinguish virtual booths having products of a certain type. For example, virtual booths including comic books may be accorded a red color scheme and virtual booths including video games may be accorded a blue color scheme.

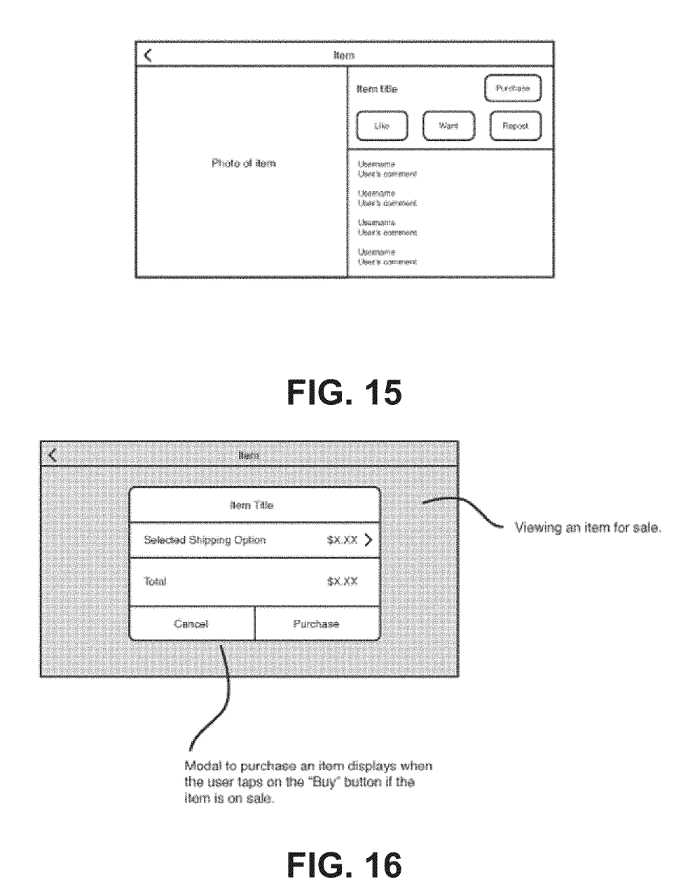

FIG. 15 depicts a product interface through which a viewer can interact with one or more products exhibited at a virtual trade fair. The product interface can be invoked, for example, when the viewer selects a product (e.g., a good or service) that is shown on a booth interface (e.g., the booth interface of FIG. 5A).

Generally, the product interface includes an image of the product and information regarding the product (e.g., a name, price, or description). In some embodiments, the product interface includes a dialog box of comments submitted by other users, notifications of purchases, etc. The dialog box may also permit the user to submit a comment regarding the product.

The product interface can also include one or more graphical icons. Examples of graphical icons include:
A like icon that, upon selection, causes the viewer to indicate an interest in the product. In some embodiments “likes” are restricted to the virtual trade fair, while in other embodiments the “likes” are associated with a social media network (e.g., Facebook®, Twitter®, or LinkedIn®)).
A want icon that, upon selection, causes the product to be added to a personal wish list associated with the viewer.
A share icon that, upon selection, causes the product to be shared with others (e.g., followers of the viewer on a social media network or other attendees of the virtual trade fair).
A purchase icon that, upon selection, initiates a purchase of the product or makes an offer to purchase the product.

FIG. 16 depicts a purchase interface through which a viewer can complete a purchase of a product exhibited at a virtual trade fair. The purchase interface may be shown, for example, responsive to detecting the selection of a purchase icon shown on a product interface (e.g., the product interface of FIG. 15). As another example, the purchase interface may be shown responsive to detecting the selection of a specific product shown on a booth interface (e.g., the booth interface of FIG. 5A). The selection may correspond to the selection of a specific piece of content visible shown on the booth interface (e.g., an image associated with the specific product).

### Virtual Booth Design

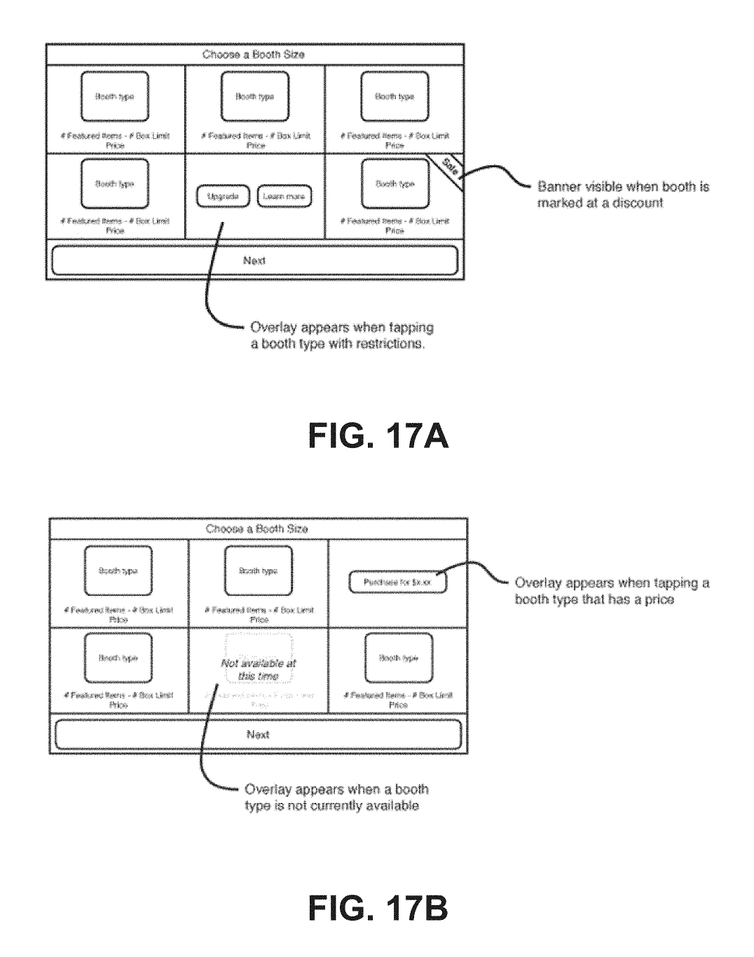

FIGS. 17A-B depict design interfaces through which an exhibitor can design a virtual booth. The exhibitor will typically first choose a booth size. Virtual booths can include boxes arranged in, for example, two rows of three columns, three rows of two columns, five rows of two columns, two rows of five columns, etc. Predefined booth sizes may also be available for selection. For example, exhibitors matching certain criteria (e.g., those exhibitors having a specified number of products, social media followers, etc.) may be able to select a “featured” booth design that includes multiple virtual tables arranged around a central graphic that includes exhibitor branding (e.g., logos and/or textual descriptions).

The user may also specify other aspects of booth design (e.g., background color, box size, etc.), the products to be shown, sale prices, availability restrictions, etc. Such information can be stored on a remote server system or a computing device used by the exhibitor to access the design interfaces. For example, the information may be retained by a mobile application executing on the computing device.

Virtual booths can also have restrictions. Restrictions may, for example, prevent exhibitors from initially choosing a restricted booth type and/or prompt exhibitors to complete additional steps (e.g., authentication processes or payment processes) before booth selections can be made. One example of a booth restriction is a restriction that requires the exhibitor provide proof of an additional account subscription (e.g., for the virtual trade fair or a specific booth type) to proceed with the booth selection. Another example of a booth restriction is a restriction that prevents the exhibitor from selecting certain booth types for a given virtual trade fair.

As shown in FIG. 17B, an overlay menu may present additional options when a booth selection is made. Here, for example, an overlay with an upgrade icon and a learn more icon directs the exhibitor to either purchase a subscription (which may be necessary to access the virtual booth design) or learn more about that booth type.

Virtual booth designs may also be associated with a purchase price. Therefore, after selecting a virtual booth design, an overlay menu may be presented that includes a purchase icon. Selecting the purchase icon may initiate the payment process. For example, selecting the purchase icon may cause a purchase interface similar to the purchase interface of FIG. 16 to be shown. Once the virtual booth design has been selected, the exhibitor can select the next icon to continue the booth creation process.

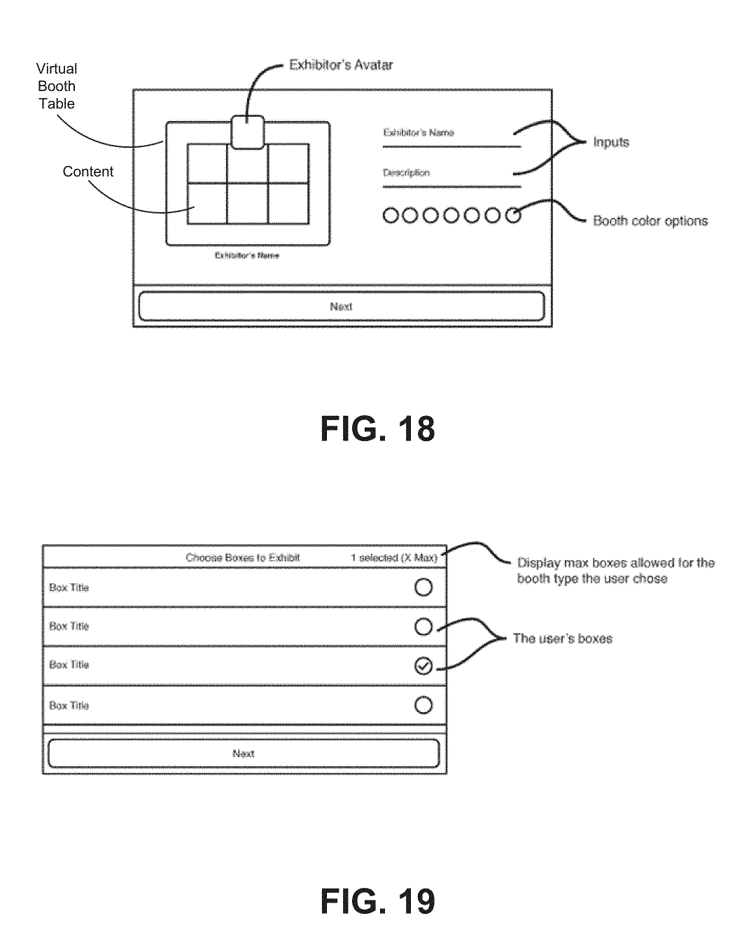

FIG. 18 depicts a configuration interface through which the exhibitor can modify design elements of the virtual booth. For example, the exhibitor may be able to add a name or description, select a color scheme from several color options, etc. A random booth color and/or default name may be assigned by default if the exhibitor does not provide such information. Once the configuration option(s) have been specified, the exhibitor can select the next icon to continue the booth creation process.

Certain elements of the configuration interface (e.g., the virtual booth table including the exhibitor's avatar and/or the content) may also be accessible from the virtual show floor. For example, the virtual booth table may be visible when a viewer zooms in on a given virtual booth. Because the virtual booth table includes both the exhibitor's avatar and content (e.g., images of products being exhibited), the viewer can quickly determine whether she would like to view additional details, content, etc. Clicking on the virtual booth table may direct the viewer to a virtual booth interface (e.g., the virtual booth interface of FIG. 5A).

FIG. 19 depicts a content interface through which the exhibitor can choose which content will be shown at the virtual booth. Each piece of content pertains to a product (e.g., a good or service) being exhibited by the exhibitor. Examples of pieces of content include documents (e.g., word processor files, spreadsheets), text passages, images, videos, audio files, etc.

As shown in FIG. 19, the exhibitor can choose which box(es) will be displayed within the virtual booth. Here, for example, the user is limited to selecting a single box pertaining to a single product. However, the exhibitor could be permitted to select multiple boxes pertaining to multiple products. Typically, each box will correspond to a single piece of content, though a single box could be associated with multiple pieces of content.

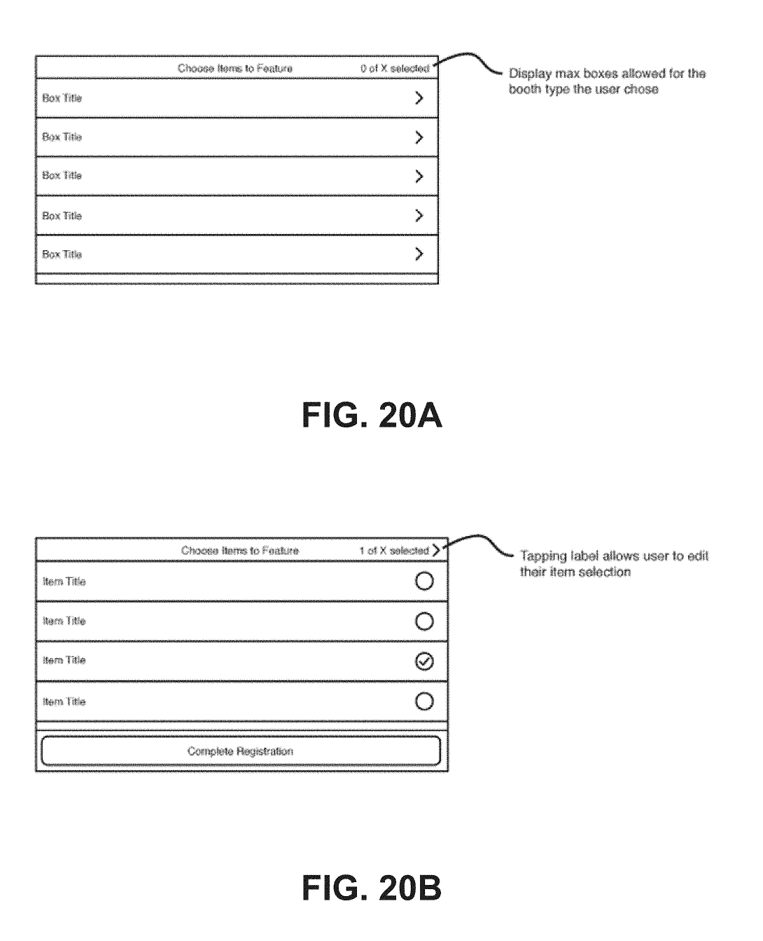

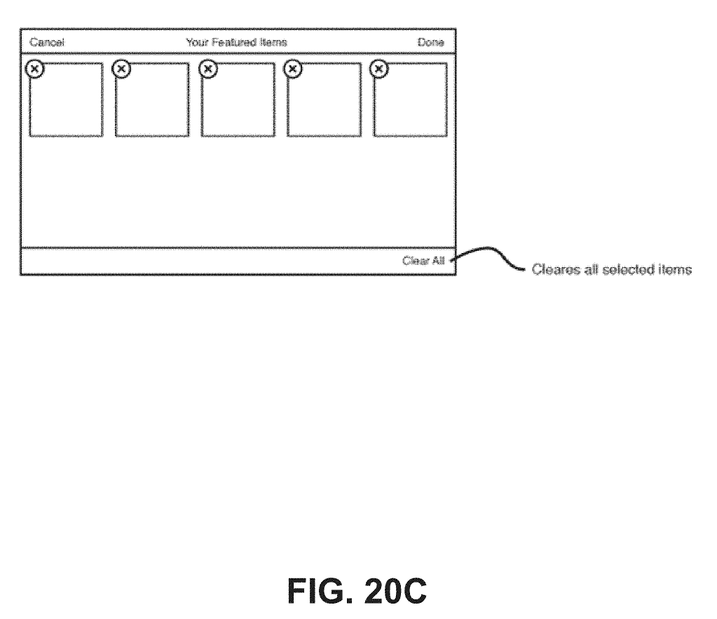

FIGS. 20A-C depict additional configuration interfaces through which the exhibitor can choose which content to feature when the virtual booth is viewed via a main show floor interface (e.g., the interfaces of FIGS. 3A-B or FIG. 4). The additional configuration interfaces illustrate the process by which the user selects the piece(s) of content to be featured.

FIG. 20A, for example, illustrates how the exhibitor can select a box, and then choose which piece(s) of content to feature from within that box. FIG. 20B, meanwhile, illustrates how the exhibitor can edit the titles assigned to specific boxes, pieces of content, etc. FIG. 20C illustrates how the user can individually manage pieces of content chosen for display. For example, the user may be able to delete pieces of content by selecting a close icon (here, visible in the upper left-hand corner) or by selecting a “clear all” option. As another example, the user may be able to modify the order in which pieces of content are shown by rearranging the corresponding boxes (e.g., via a drag-and-drop interface).

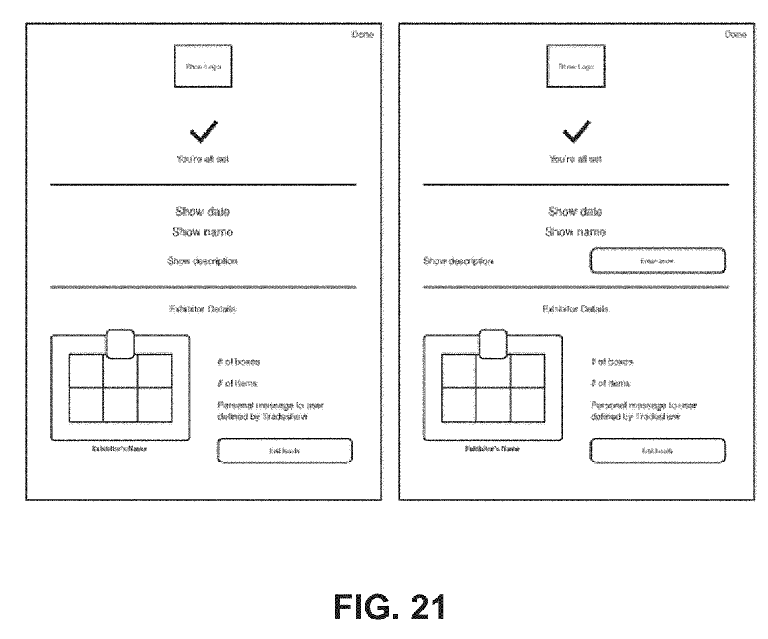

After completing the design of a virtual booth, a confirmation interface may be presented to the exhibitor. FIG. 21 depicts two examples of confirmation pages that may serve as exhibitor overviews for the virtual trade fair. If the virtual trade fair is currently running, then an enter show icon may be shown on the confirmation page that allows the exhibitor to be directed directly to the virtual booth.

### Virtual Trade Fair Details

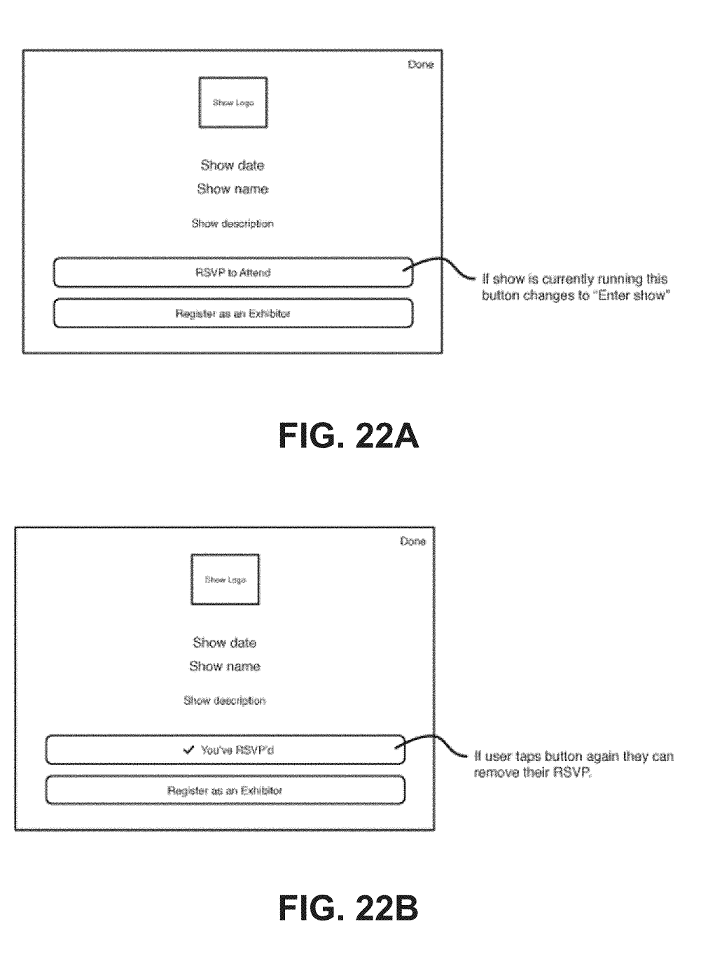

FIGS. 22A-B depict details interfaces that include details regarding a virtual trade fair. A details interface may be made accessible in several different ways (e.g., via a website, email, or social media network). The details interface includes relevant information such as when the virtual trade fair will begin/end, whether registration is necessary, example exhibitor(s), theme, name/title, etc.

A details interface may permit a viewer to register for the virtual trade fair as an attendee or an exhibitor. Here, for example, both details interfaces include an RSVP icon that attendees can select to confirm an interest in attending the virtual trade fair and a registration icon that exhibitors can select to initiate the virtual booth design process (e.g., as shown in FIGS. 17A-21).

An additional icon may be shown when the virtual trade fair begins. For example, an enter icon may be shown that, upon selection, causes the viewer to enter the virtual trade fair. Alternatively, the additional button may replace the RSVP icon. Thus, a viewer may indicate an interest in the virtual trade fair by simply entering the virtual trade fair rather than RSVP′ing.

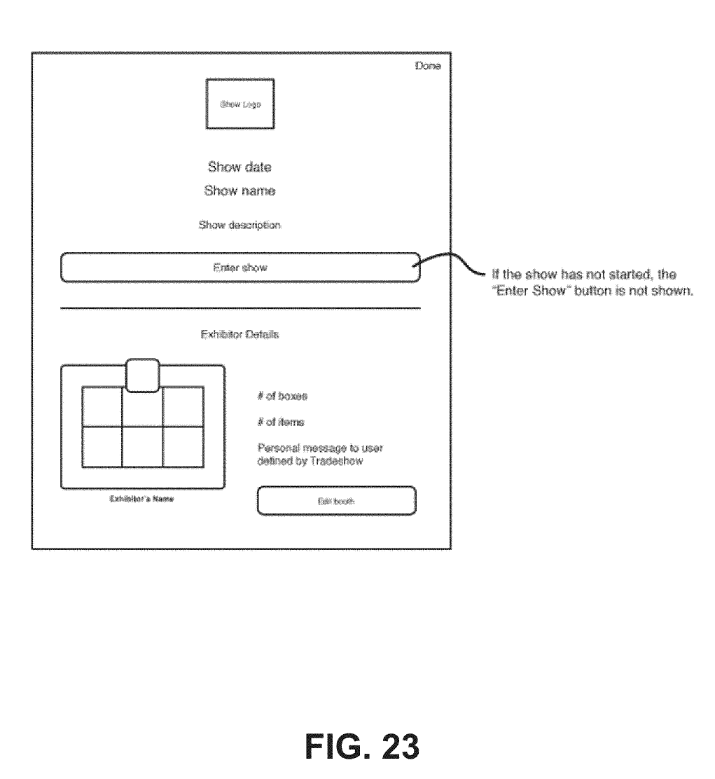

FIG. 23 depicts a confirmation interface that may be shown to a viewer who has registered as an exhibitor. Because the viewer has registered to exhibit product(s), there is no RSVP icon on the confirmation interface. Once the virtual trade fair has started, an enter icon may be shown that, upon selection, causes the viewer to be directed to the viewer's virtual booth.

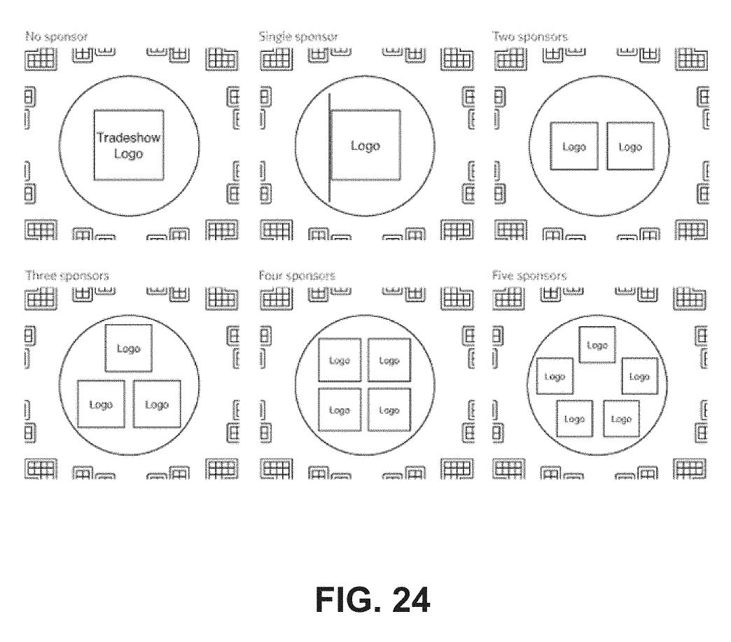

In some instances, one or more enterprises (e.g., companies) may choose to sponsor a virtual trade fair. FIG. 24 depicts an overview view of a virtual show floor that includes sponsor names, logos, etc. Placement may depend on the number of sponsors for the virtual trade fair. For example, the logo corresponding to a primary sponsor may be placed in the center circle of the virtual show floor, while the logo(s) corresponding to secondary sponsor(s) may be arranged around the outer perimeter of the virtual show floor. In some embodiments, the center circle of the virtual show floor includes multiple names, logos, etc.

Additionally or alternatively, the virtual trade fair may include featured virtual booths corresponding to the most popular exhibitors, sponsors, etc. Featured virtual booths are generally arranged such that they are easy to find on the virtual show floor. For example, virtual booths may be positioned at specified locations (e.g., the end of each aisle) or in accordance with a specified pattern (e.g., every five virtual booths). Featured virtual booths may also be visually distinguishable from other virtual booths. For example, featured virtual booths may be generated in accordance with a consistent color scheme.

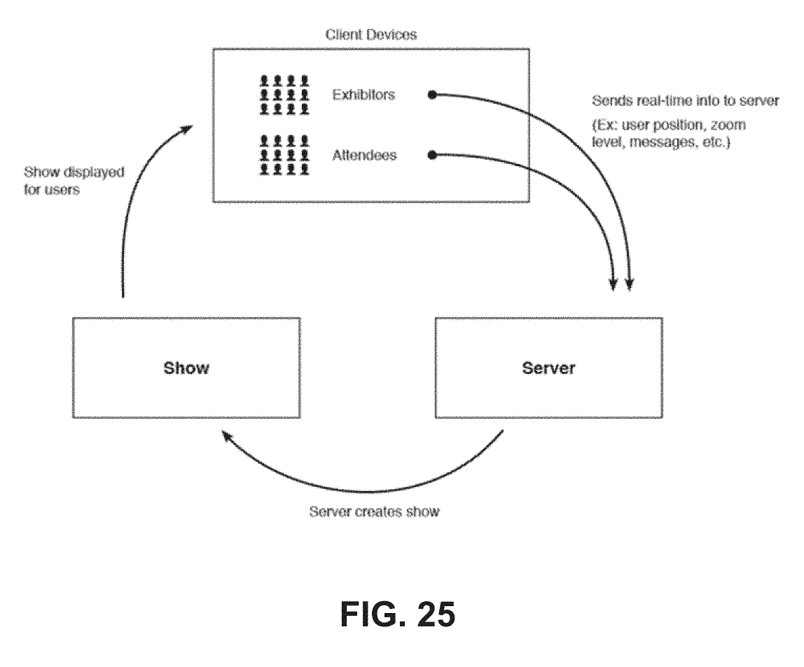

FIG. 25 includes a high-level flow diagram illustrating how a remote server system can support a virtual trade fair. Here, the remote server system includes a single server. However, the remote server system could include various combinations of network-accessible computing device(s). The virtual trade fair may be accessible through, for example, a mobile application operating on the computing device (also referred to as the “client device”) of a viewer. Viewers can include exhibitors and attendees.

When the viewer interacts with the mobile application (e.g., by specifying product(s) to be exhibited or selecting a virtual booth corresponding to an exhibitor), the user input can be provided to the remote server system in real time. The mobile application may also continually provide certain types of information (e.g., viewer position on the virtual show floor, zoom level, messages) to the remote server system.

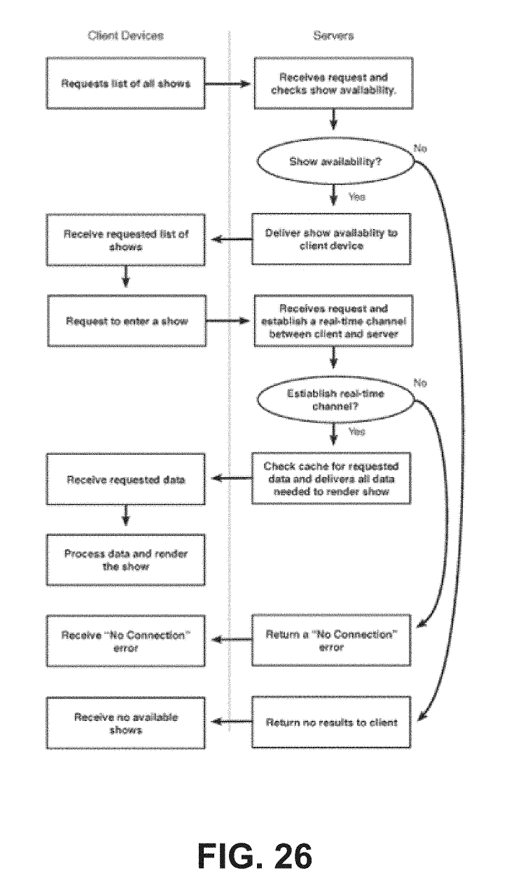

FIG. 26 depicts a process for entering and loading the virtual show floor of a virtual trade fair. A computing device associated with a viewer (e.g., an exhibitor or attendee) initially submits a request for a list of all accessible virtual trade fairs to a remote server system responsible for supporting the virtual trade fair. After receiving the request, the remote server system can check whether any virtual trade fairs are currently accessible.

If no virtual trade fairs are accessible, then the remote server system can forward a message to the computing device indicating that there are no valid results. However, if at least one virtual trade fair is accessible, then the remote server system can forward a list of the accessible virtual trade fair(s) to the computing device for review by the viewer.

Thereafter, the computing device may receive user input indicative of a selection of a particular virtual trade fair by the viewer. The computing device can forward the selection to the remote server system, which can establish a real-time communication channel between itself and the computing device upon reception of the selection. If the remote server system is unable to establish the communication channel, then the remote server system can forward a message to the computing device indicating that no connection could be formed. However, if the remote server system is able to establish the communication channel, then the remote server system can search a storage (e.g., a cache or database) for data necessary to render the virtual trade fair and deliver the data to the computing device via the communication channel. The computing device can process the data and use it to render the virtual trade fair.

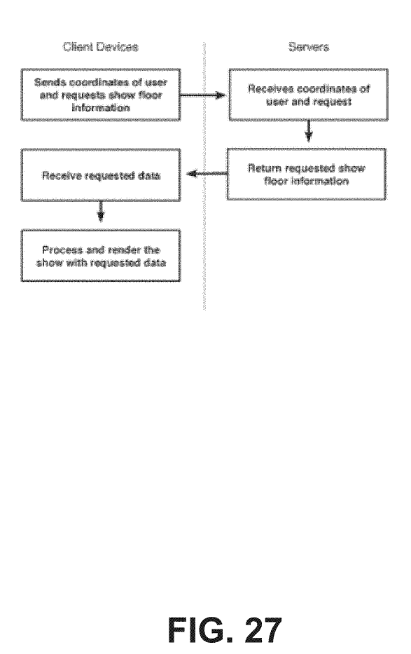

FIG. 27 depicts a process for loading a virtual show floor while a viewer navigates a virtual trade fair. Initially, a computing device associated with the viewer sends a request for show floor information (as well as viewer coordinates) to a remote server system. As noted above, in some embodiments the computing device is configured to periodically send the viewer coordinates (e.g., every 30 or 60 seconds) or continually send the viewer coordinates in real time as the viewer navigates the virtual show floor.

After receiving the request for show floor information, the remote server system can deliver the requested show floor information. The computing device can then render the virtual show floor with the requested show floor information. For example, the virtual show floor may be updated with the appropriate exhibitors, products, attendees, etc., based on the current location of the viewer on the virtual show floor.

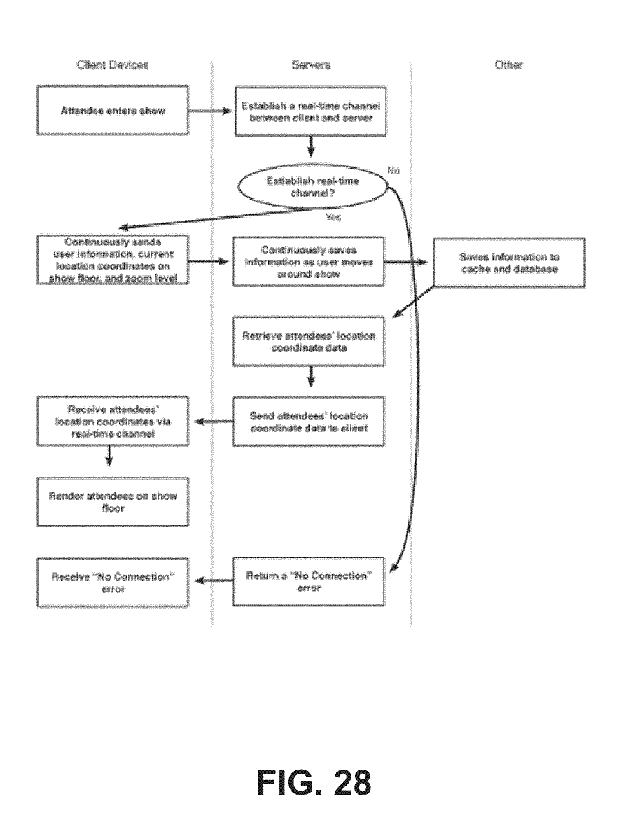

FIG. 28 depicts a process for rendering attendees on the virtual show floor of a virtual trade fair. An attendee initially enters the virtual trade fair. For example, the attendee may initiate an application on a computing device (e.g., a mobile phone) and select the virtual trade fair from a list of available virtual trade fairs.

Responsive to receiving an indication that the attendee entered the virtual trade fair from the computing device, a remote server system can establish a real-time communication channel between itself and the computing device. If the remote server system is unable to establish the communication channel, then the remote server system can forward a message to the computing device indicating that no connection could be formed. However, if the remote server system is able to establish the communication channel, then the remote server system can prompt the computing device to send attendee information to the remote server system. In some embodiments, the computing device is configured to continuously send the attendee information to the remote server system in real time. Examples of attendee information include coordinates corresponding to the attendee's current location on the virtual show floor and zoom level.

The remote server system can save attendee information received from the computing device as the attendee moves around the virtual show floor. In some embodiments, another computing device (e.g., a back-up computer server) saves the attendee information to a storage (e.g., a cache and/or database). The remote server system can then retrieve attendee coordinate data corresponding to other attendees of the virtual trade fair and send the attendee coordinate data to the computing device. The computing device can use the attendee coordinate data to render visual representations of the other attendees on the virtual show floor. For example, each attendee may be represented as a dot whose motion mimics the movement of the corresponding attendee along the virtual show floor.

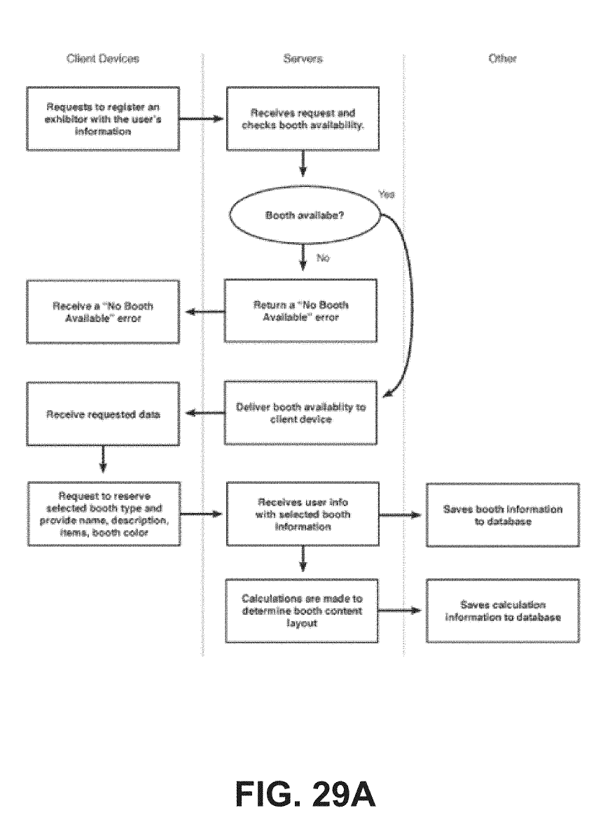

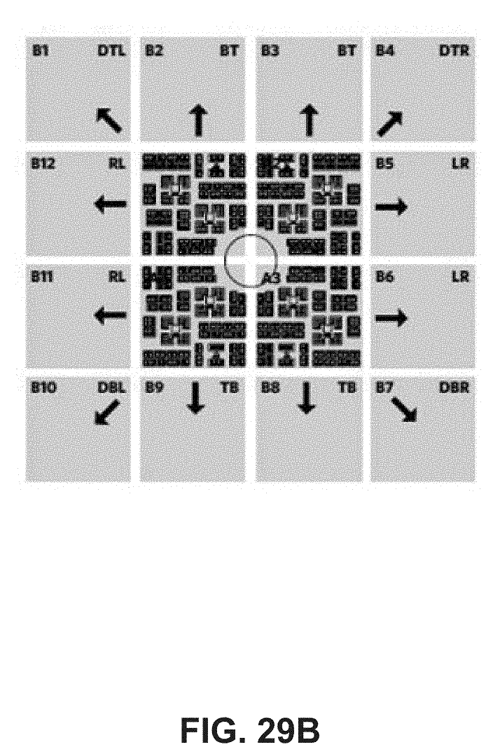

FIG. 29A depicts a process for registering exhibitors and adding virtual booths to the virtual show floor of a virtual trade fair. A computing device associated with an exhibitor initially submits a registration request that includes exhibitor information. The registration request may be submitted by the computing device responsive to receiving user input from the exhibitor. For example, the exhibitor may provide the exhibitor information through a series of interfaces accessible via an software program (e.g., mobile application) executing on the computing device (e.g., a mobile phone).

After receiving the registration request from the computing device, a remote server system can check whether any virtual booths remain available for the virtual trade fair. If no virtual booths are available, then the remote server system can forward a message to the computing device indicating that no virtual booths are available are presently available. Note, however, that the remote server system could forward another message to the computing device upon discovering that a virtual booth has become available (e.g., due to withdrawal by another exhibitor). If at least one virtual booth is available, then the remote server system can forward a message specifying the virtual booth availability to the computing device.

The computing device can present the available virtual booth for review by the exhibitor. After receiving user input indicative of a selection of the available virtual booth and/or a virtual booth type, the computing device can forward a message specifying the selection(s) to the remote server system. In some embodiments, the message also includes the exhibitor name, exhibitor description, virtual booth color, pieces of content, etc.

The remote server system or some other computing device (e.g., a back-up computer server) can save some or all of the information included in the message to a storage (e.g., a cache or database). The remote server system can also make calculations to determine the booth content layout. The remote server system may save the calculations to a storage.

The process can be repeated as exhibitors continue to register, and the virtual show floor can be automatically expanded accordingly. For example, exhibitors may be arranged in a spiral pattern based on registration date where the newest exhibitors are positioned furthest from the center. As another example, exhibitors may be arranged in a concentric pattern where the newest exhibitors are positioned furthest from the center. Thus, virtual show floors can be automatically scaled to support a nearly unlimited number of exhibitors. FIG. 29B illustrates an example of how the virtual show floor can be systematically populated and expanded to accommodate exhibitors.

After the remote server system determines the booth content layout, the virtual booth for the exhibitor can be made accessible to attendees of the virtual trade fair. In some embodiments, an administrator is able to manually move/delete existing virtual booths and/or add new virtual booths to the virtual show floor. Moreover, the administrator may be able to manually override the automatic placement of a virtual booth along the virtual show floor by “reserving” a spot for a particular exhibitor. The particular exhibitor can then proceed to register, and the platform can assign the particular exhibitor to the virtual booth that was automatically reserved by the platform or manually reserved by the administrator.

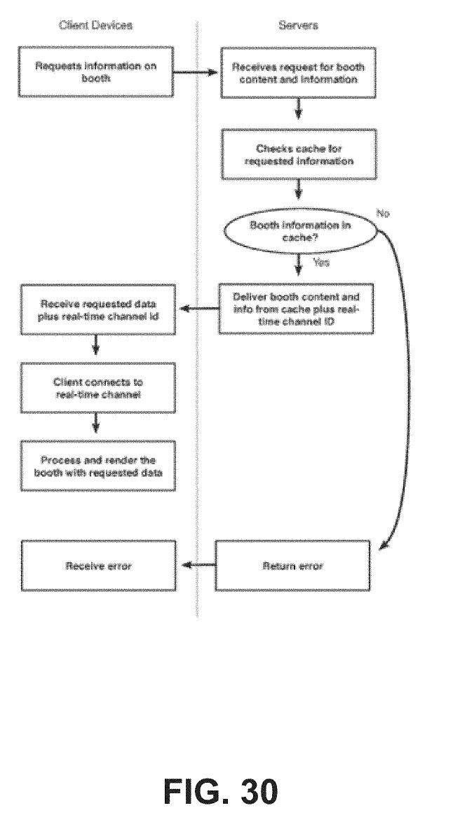

FIG. 30 depicts a process for visiting a virtual booth at a virtual trade fair. Generally, a viewer (e.g., an attendee) will traverse the virtual show floor of the virtual trade fair via an overhead view (as shown in FIGS. 3A-B) or a three-dimensional perspective view (as shown in FIG. 4) presented on the display of a computing device. In some instances, the computing device may receive user input indicative of a selection of a virtual booth. Such action can prompt the computing device to submit a request for booth information to a remote server system responsible for supporting the virtual trade fair.

After receiving the request for booth information, the remote server system can check a storage (e.g., a cache or database) for the booth information. If the remote server system is unable to find the booth information, then the remote server system can forward a message to the computing device indicating that no booth information is available. However, if the remote server system is able to find the booth information, then the remote server system can deliver the booth information to the computing device.

The booth information may be accompanied by additional content (e.g., pieces of content corresponding to specific products being exhibited by the exhibitor) and/or a communication channel identifier. In such embodiments, the computing device can use the communication channel identifier to connect to the remote server system via a real-time communication channel. The computing device can then render the virtual booth using the booth information and/or the additional content.

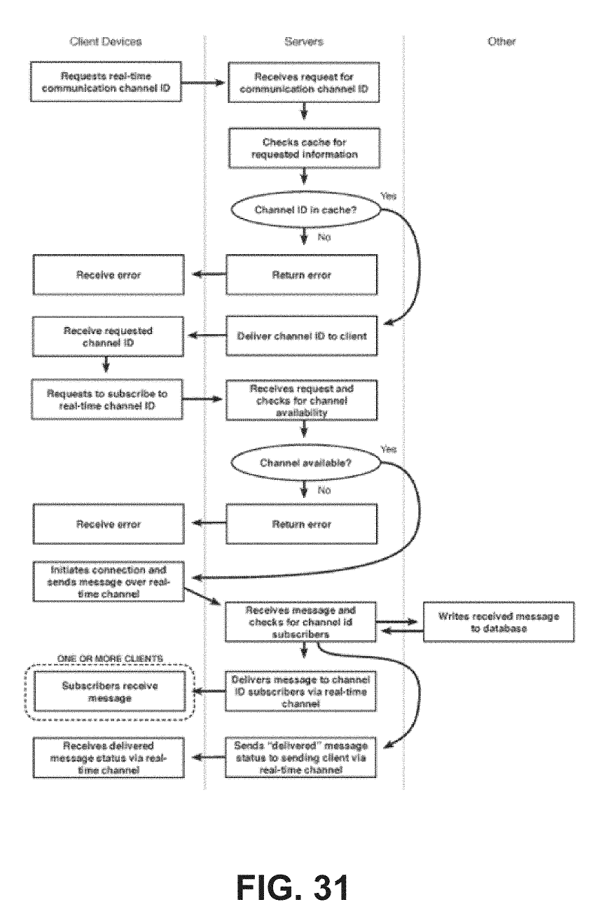

FIG. 31 depicts a process for sending and receiving messages at a virtual trade fair. A computing device associated with a viewer (e.g., an exhibitor or attendee) initially submits a request for a communication channel identifier to a remote server system. Responsive to receiving the request, the remote server system can check a storage (e.g., a cache or database) for the communication channel identifier. If the remote server system is unable to find the communication channel identifier, then the remote server system can forward a message to the computing device indicating that the communication channel identifier is not available. However, if the remote server system is able to find the communication channel identifier, then the remote server system can forward the communication channel identifier to the computing device.

The computing device can submit a request to subscribe to the communication channel to the remote server system. Responsive to receiving the request, the remote server system can check the availability of the communication channel. If the communication channel is not available, then the remote server system can forward a message to the computing device indicating that the communication channel is not currently available. Communication channels may not be available for several reasons. For example, the remote server system may only support a specified number of communication channels at one time, the communication channel may have already been claimed by another viewer, etc. If the communication channel is available, then the remote server system can forward a message to the computing device indicating that communication via the communication channel is presently possible.

The computing device can then initiate a connection with the remote server system via the communication channel. For example, the computing device may send a message over the communication channel in real time. Generally, the remote server system can associate an incoming message with a specific communication channel identifier based on which communication channel was responsible for receiving the incoming message. However, the remote server system could also parse incoming messages to identify embedded communication channel identifiers. After receiving the message, the remote server system can check for subscribers to the communication channel identifier. In some embodiments, the remote server system or some other computing device (e.g., a back-up computer server) writes incoming messages received from the computing device to a storage (e.g., a database).

The remote server system can then deliver the message to all subscribers. More specifically, the remote server system can create copies of the original message that are delivered to the subscribers via dedicated communication channels established using the communication channel identifier. The remote server system may also deliver a confirmation message to the computing device responsible for generating the original message following delivery of the copies to the subscriber(s).

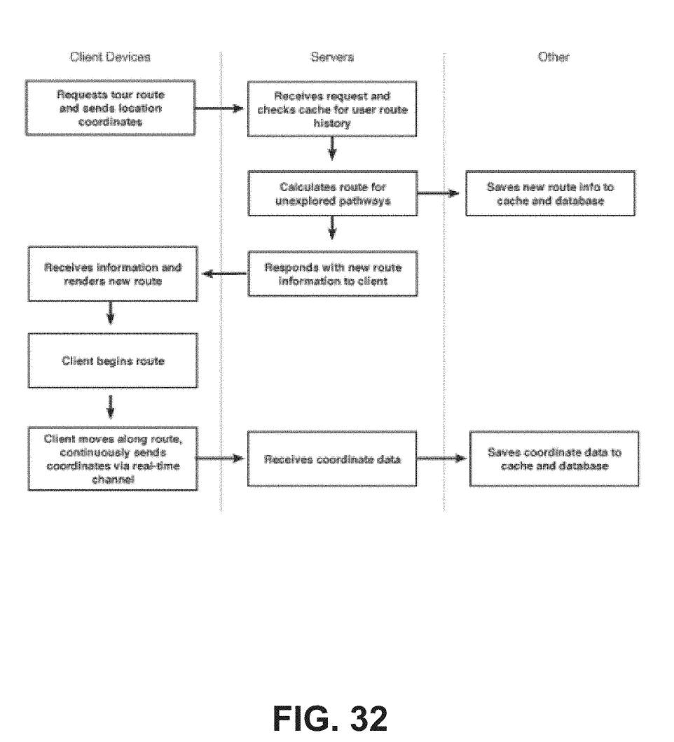

FIG. 32 depicts a process for creating a guided tour of multiple virtual booths at a virtual trade fair. A computing device associated with a viewer (e.g., an exhibitor or attendee) can initially submit a request for a guided tour route to a remote server system. The request can also include location coordinates indicative of a current location of the viewer on the virtual show floor of the virtual trade fair.

After receiving the request, the remote server system can check a storage (e.g., a cache) for viewer route history. The viewer route history is generated based on past location coordinates received by the computing device, and thus indicates where the viewer has already traveled. The remote server system can then calculate one or more routes of unexplored pathways that guide the viewer past virtual booths that have not yet been visited. In some embodiments, the route(s) are saved to a storage (e.g., a cache or database) accessible to the remote server system.

The remote server system can transmit the route(s) of unexplored pathways to the computing device. After receiving the route(s) of unexplored pathways, the computing device can render a route and direct the viewer along the route. The route may be selected from the route(s) based on a specified preference of the viewer, random selection, etc. For example, the viewer may choose a route that guides her past virtual booths including comic books before virtual booths including video games. As another example, the viewer may choose a route that guides her past an assortment of virtual booths including different products.

As the viewer moves along the route, the computing device can continuously send location coordinates to the remote server system via a communication channel. The remote server system may use the location coordinates to alter the route, improve the design of future routes, detect which virtual booth(s) the viewer has visited, etc. In some embodiments, the location coordinates are saved to the storage accessible to the remote server system.

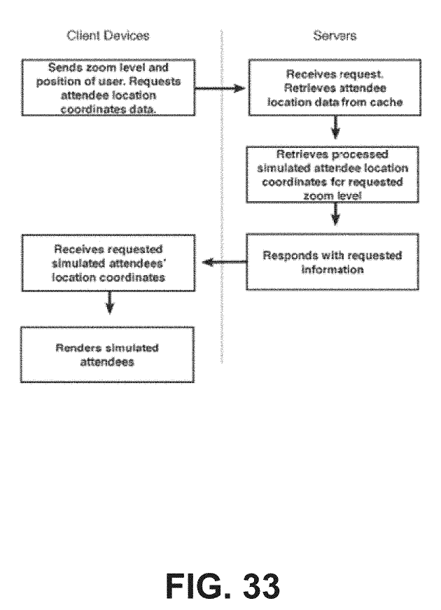

FIG. 33 depicts a process for populating a virtual show floor with simulated attendees. Initially, a computing device associated with a viewer sends a request for attendee location coordinate data to a remote server system. The request may also include other information, such as the current zoom level, viewer coordinates, etc.

After receiving the request, the remote server system can retrieve attendee location coordinate data from a storage (e.g., a cache). In some embodiments, the remote server system processes the attendee location coordinate data based on the other information supplied by the computing device. For example, the remote server system may determine how many simulated attendees should be rendered based on the current zoom level (e.g., fewer simulated attendees at higher zoom levels). As another example, the remote server system may determine where simulated attendees should be rendered based on the viewer coordinates (e.g., to account for the outer boundaries of the virtual show floor).

After retrieving the attendee location coordinate data, the remote server system can deliver the attendee location coordinate data to the computing device. The computing device can then use the attendee location coordinate data to render the simulated attendees on the virtual show floor.

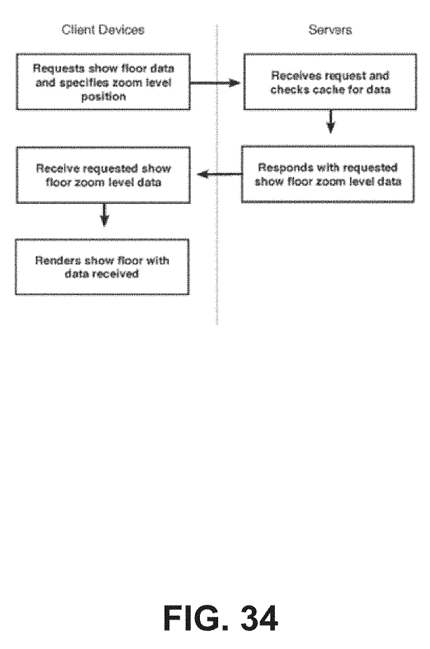

FIG. 34 depicts a process for rendering a virtual show floor based on the current zoom level. Initially, a computing device associated with a viewer sends a request for show floor data to a remote server system. The request will typically specify the current zoom level of the virtual show floor.

After receiving the request, the remote server system can retrieve the show floor data from a storage (e.g., a cache) and deliver the show floor data to the computing device. After receiving the show floor data, the computing device can use to show floor data to render elements of the virtual show floor. Elements can include, for example, virtual booths, booth identifiers, visual representations (e.g., of actual attendees and simulated attendees), etc.

The elements visible on the virtual show floor can vary dramatically based on the current zoom level. For example, very few details may be visible at the lowest zoom level, while many details may be visible at the highest zoom level. Because viewers will often quickly change the zoom level as they navigate the virtual show floor, the remote server system may provide multiple sets of show floor data to the computing device. Each set of show floor data may correspond to a different zoom level. In such embodiments, the computing device need not submit a separate request for show floor data each time the viewer changes the zoom level. Instead, the computing device may continually or periodically submit a request for multiple sets of show floor data as the viewer traverses the virtual show floor.

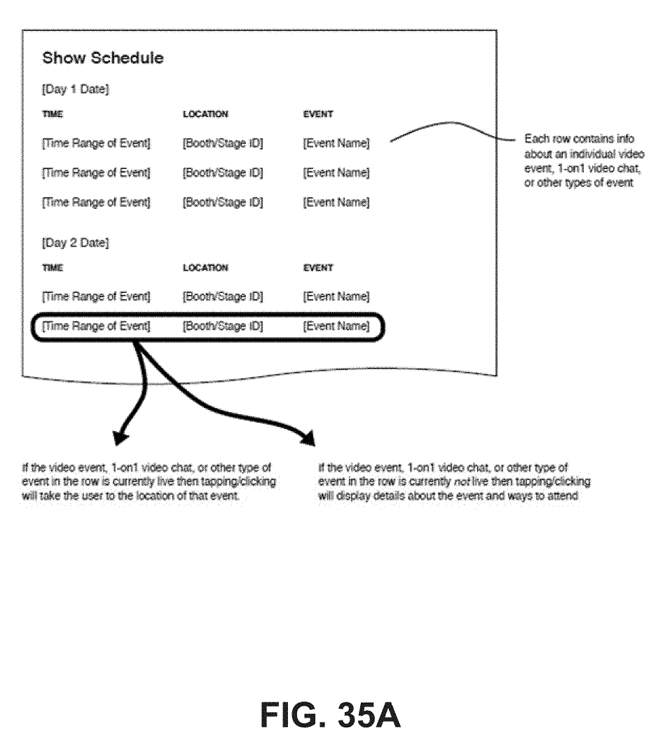

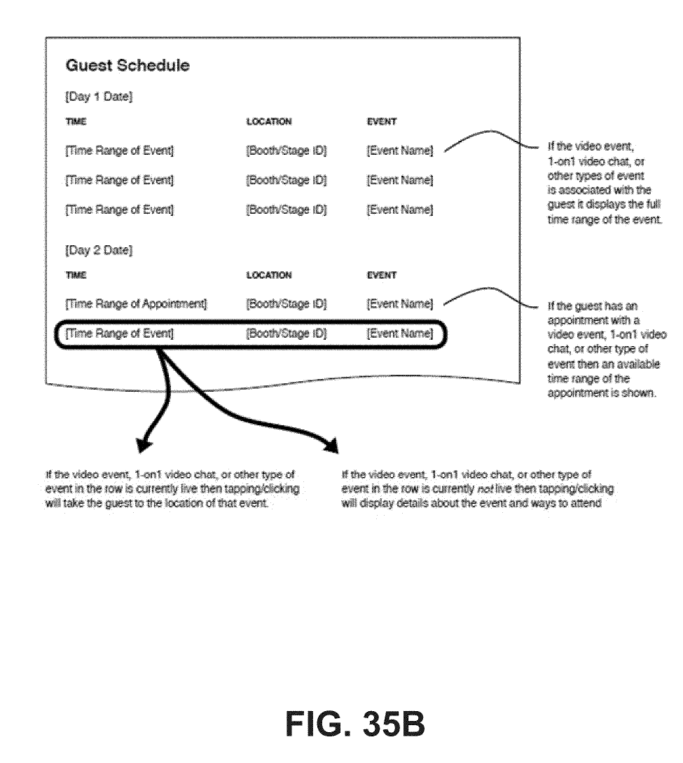

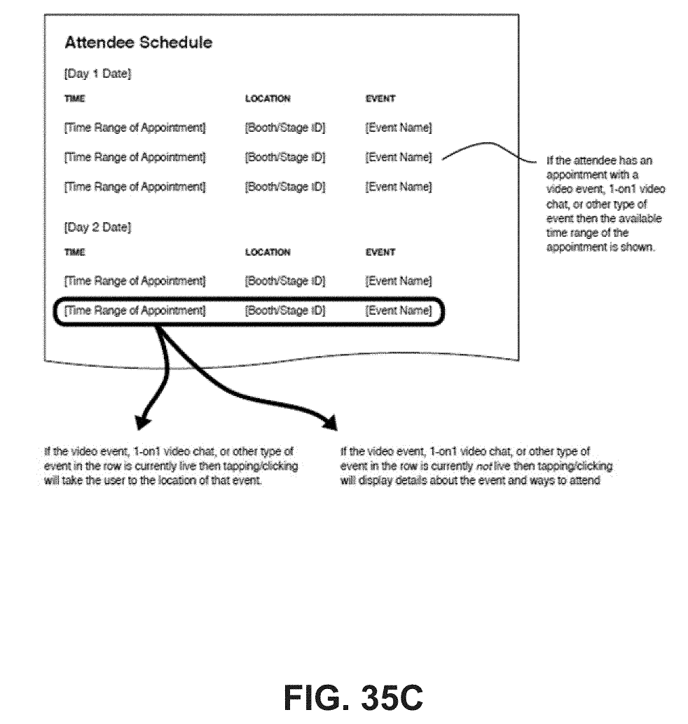

FIGS. 35A-C illustrate several different types of schedules that may be dynamically populated and automatically created by a platform (e.g., platform 100 of FIG. 1).

FIG. 35A, for example, depicts a show schedule that includes video events, one-on-one video chats, and/or other types of events. These events can be manually scheduled by an administrator and/or automatically scheduled by the platform. Here, each row includes information about a single event. Selecting a live event may automatically direct a viewer to the live event, while selecting a future event or a past event may cause event details to be shown.

FIG. 35B depicts a guest schedule that includes video events, one-on-one video chats, and/or other types of events. For example, if the guest has scheduled any events, then those events can be automatically added to the guest schedule. Selecting a live event may automatically direct the guest to the live event, while selecting a future event or a past event may cause event details to be shown. In some embodiments, events are intelligently batched on the guest schedule. For example, if the guest is scheduled to participate in a series of one-on-one video chats, the guest schedule may include a single schedule entry blocking the entire duration (rather than individual schedule entries for each one-on-one video chat).

FIG. 35C depicts an attendee schedule that includes video events, one-on-one video chats, and/or other types of events. Generally, an event will be added to the attendee schedule after the attendee has register for the event. Selecting a live event may automatically direct the attendee to the live event, while selecting a future event or a past event may cause event details to be shown.

### Remarks

The foregoing examples of various embodiments have been provided for the purposes of illustration and description. These examples are not intended to be exhaustive. Many variations will be apparent to one skilled in the art. Certain embodiments were chosen in order to best describe the principles of the technology introduced herein, thereby enabling others skilled in the relevant art to understand the claimed subject matter, the various embodiments, and the variations that may be suited to particular uses.

The language used in the specification has been principally selected for readability and instructional purposes. It may not have been selected to delineate or circumscribe the subject matter. Therefore, it is intended that the scope of the technology be limited not by this specification, but rather by any claims that issue based hereon. Accordingly, the disclosure of the technology is intended to be illustrative (rather than limiting) of the scope of the technology, which is set forth in the following claims.

What is claimed is:

1. A computer-implemented method for dynamically presenting content provided by exhibitors as attendees navigate a virtual trade fair, the method comprising:
displaying a first interface that includes an overhead view of a virtual show floor that includes multiple virtual booths on a display of a computing device;
performing an artificial intelligence operation to identify a specified series of virtual booths;
systematically guiding an attendee through the specified series of virtual booths;
continually monitoring the boundaries of the first interface to detect instances of user input; and
responsive to receiving user input indicative of a selection of a particular virtual booth associated with a particular exhibitor,
automatically displaying a second interface that includes
content chosen for display by the particular exhibitor during a registration process, and
a navigation icon enabling the attendee to navigate the content,
wherein the second interface at least partially overlaps the first interface.

2. The computer-implemented method of claim 1, wherein the first interface includes a separate visual representation for each attendee of the virtual trade fair.

3. The computer-implemented method of claim 2, wherein each visual representation moves along the virtual show floor in real time as the corresponding attendee navigates the virtual trade fair.

4. The computer-implemented method of claim 1, wherein the first interface includes a menu icon.

5. The computer-implemented method of claim 4, further comprising:
responsive to receiving user input indicative of a selection of the menu icon, automatically displaying a dropdown menu that includes
an invoice subentry that, upon selection, causes display of invoices for any purchases made by the attendee,
a message subentry that, upon selection, causes display of an interface for messaging exhibitors, attendees, or both, and
a notification subentry that, upon selection, causes display of any pending notifications associated with the virtual trade fair.

6. The computer-implemented method of claim 4, wherein the menu icon is automatically hidden from view while the attendee is systematically guided through the specified series of virtual booths.

7. The computer-implemented method of claim 1, wherein the second interface further includes at least one of:
biographical information associated with the particular exhibitor,
a social media icon that, upon selection, directs the attendee to a social media account associated with the particular exhibitor,
a share icon that, upon selection, enables the attendee to alert another attendee of the particular exhibitor, and
a chat icon that, upon selection, enables the attendee to initiate a chat with the particular exhibitor.

8. The computer-implemented method of claim 1, wherein the content shown within the second interface includes multiple pieces of content corresponding to separate products exhibited by the particular exhibitor.

9. The computer-implemented method of claim 8, wherein the multiple pieces of content are ordered based on similarity to a user preference specified by the attendee during a registration process.

10. The computer-implemented method of claim 1, wherein the first interface includes a directory icon that, upon selection, enables the attendee to browse the exhibitors at the virtual trade fair.

11. A computer-implemented method for managing content to be shown to attendees of a virtual trade fair, the method comprising:
displaying a first interface that includes
biographical information associated with an exhibitor,
content entries corresponding to separate products exhibited by the exhibitor, and
a sit icon that, upon selection, enables the exhibitor to interact with one or more attendees browsing a virtual booth associated with the exhibitor;
responsive to receiving user input indicative of a selection of the sit icon, generating a visual representation of each attendee viewing the virtual booth to produce one or more visual representations;
displaying a second interface that includes the one or more visual representations arranged proximate to the content entry being viewed by the corresponding attendee;
dynamically modifying the visual representations on the second interface in real time as new attendees enter the virtual booth and existing attendees leave the virtual booth; and
enabling the exhibitor to interact with a given attendee by selecting the visual representation corresponding to the given attendee.

12. The computer-implemented method of claim 11, wherein the second interface includes:
a current count of attendees viewing the virtual booth; and
a historical count of attendees who have visited the virtual booth during the virtual trade fair.

13. The computer-implemented method of claim 11, wherein the content entries are shown in boxes arranged in rows and columns.

14. The computer-implemented method of claim 13, further comprising:
enabling the exhibitor to modify a sequence in which attendees view the content entries by rearranging the boxes.

15. A computer-readable medium storing instructions that, when executed by a processor, perform a method comprising:
displaying a first interface that includes a three-dimensional view of a virtual show floor that includes multiple virtual booths corresponding to multiple exhibitors;
performing an artificial intelligence operation to identify a specified sequence of virtual booths;
systematically guiding an attendee through the specified sequence of virtual booths; and
responsive to receiving user input indicative of a selection of a particular virtual booth associated with a particular exhibitor,
displaying a second interface that includes content chosen for display by the particular exhibitor during a registration process.

16. The computer-readable medium of claim 15, wherein the instructions are programmed to be executed by a virtual reality headset.

17. The computer-readable medium of claim 15, wherein each virtual booth of the specified sequence of virtual booths is positioned proximate to an avatar associated with the corresponding exhibitor.

18. The computer-readable medium of claim 17, wherein the avatar is an logo or a digital representation of a person.

19. The computer-readable medium of claim 15, wherein the second interface at least partially overlays the first interface.

20. The computer-readable medium of claim 15, wherein the first interface includes a directory icon that, upon selection, enables the attendee to browse the exhibitors at the virtual trade fair.

21. The computer-readable medium of claim 15, wherein the first interface includes a search bar that enables the attendee to search a directory of the multiple exhibitors.
